(19) United States
(12) Patent Application Publication
(10) Pub. No.: US 2024/0329315 A1
(43) Pub. Date: Oct. 3, 2024

(54) OPTICAL COUPLER, VISIBLE LIGHT SOURCE MODULE AND OPTICAL ENGINE

(71) Applicant: TDK Corporation, Tokyo (JP)

(72) Inventors: Yasuhiro TAKAGI, Tokyo (JP); Hiroki HARA, Tokyo (JP); Atsushi SHIMURA, Tokyo (JP)

(73) Assignee: TDK Corporation, Tokyo (JP)

(21) Appl. No.: 18/617,839

(22) Filed: Mar. 27, 2024

(30) Foreign Application Priority Data
Mar. 30, 2023 (JP) 2023-055019

(51) Int. Cl. G02B 6/293; G02B 26/10

(52) U.S. Cl. CPC G02B 6/29344; G02B 26/105

(57) ABSTRACT

The optical coupler is a multimode interference type optical coupler that couples a plurality of laser lights of different wavelengths. The optical coupler includes an optical coupling main body, two input taper portions which are tapered input ports that are disposed on the input side of the optical coupling main body and of which the width of each becomes narrower as it is away from a connection end with the optical coupling main body, and one output taper portion which is a tapered output port that is disposed on the output side of the optical coupling main body and of which the width becomes narrower as it is away from a connection end with the optical coupling main body.

### CROSS-REFERENCE TO RELATED APPLICATION

Priority is claimed on Japanese Patent Application No. 2023-055019, filed Mar. 30, 2023, the content of which is incorporated herein by reference.

### BACKGROUND OF THE INVENTION

### Field of the Invention

The present invention relates to an optical coupler, a visible light source module, and an optical engine.

### Description of Related Art

Currently, glasses type terminals are being considered in xR technologies such as virtual reality (VR) and augmented reality (AR). Particularly in recent years, retinal scanning displays that allow a user to visually recognize images by focusing two-dimensionally scanned light on the user's retina have attracted attention. In general, in a retinal scanning display, three-color visible light emitted from light sources such as a light emitting diode (LED) and a laser diode (LD) corresponding to each color of R (red), G (green), and B (blue) are coupled onto one optical axis. The coupled three-color visible light is transmitted to an image display part. The image display part scans the transmitted light two-dimensionally and makes it be incident on the user's pupil. Due to this incident light forming an image on the user's retina, the user visually recognizes the image. In this case, the retina is a screen that displays the image.

For example, Patent Document 1 discloses a configuration of a retinal projection display using a Mach-Zehnder type optical modulator.

### PATENT DOCUMENTS

[Patent Document 1] Japanese Patent No. 6728596
[Patent Document 2] Japanese Patent No. 6787397
[Patent Document 3] Japanese Patent No. 6572377
[Patent Document 4] Japanese Unexamined Patent Application, First Publication No. 2012-48071
[Patent Document 5] Japanese Unexamined Patent Application, First Publication No. 2020-27170

### SUMMARY OF THE INVENTION

In the retinal projection display disclosed in Patent Document 1, although a plurality of optical waveguides are placed close to each other at an emission part, since they are not coupled, the optical axis for each of wavelengths is different, and control of the emitted light becomes complicated.

However, in Patent Document 1, the optical waveguides are only placed close to each other at the emission part and are not coupled. Therefore, the optical axis for each of the wavelengths is different, and thus the control of the emitted light becomes complicated.

Further, Patent Document 2 discloses a visible light modulator using a lithium niobate film. There is a need for an RGB optical coupler that can be connected or integrated with a visible light modulator using a lithium niobate film, but it has not yet been considered.

Regarding the coupling of visible light, directional couplers are generally being considered (refer to, for example, Patent Document 3). They are made of a glass-based material and thus have excellent stability, but when a lithium niobate substrate with a large Δn is used, a coupling length becomes long, and miniaturization is not possible.

Patent Document 4 and Patent Document 5 disclose configurations of RGB couplers using multimode interferometers (MMI), but both are made of glass-based materials, and the configuration using a lithium niobate film is not disclosed at all.

In the MMI type optical coupler, a plurality of input signals are input to the optical input side using a plurality of waveguide ports, and all the input signals are coupled and output as an output signal using a single waveguide port on the optical output side.

The MMI type optical coupler is an optical coupler using characteristics in which a large number of modes generated within an optical coupler having a wide width interfere with each other for each wavelength and an image is formed (converged) at a specific position.

The present disclosure has been made in view of the above problems, and an object thereof is to provide an optical coupler, a visible light source module, and an optical engine capable of being connected to or integrated with an optical modulator using a lithium niobate film and capable of being made smaller than conventional ones.

The present disclosure provides the following means to solve the above problems.

A first aspect of the present disclosure is a multimode interference type optical coupler that couples a plurality of laser lights of different wavelengths, including an optical coupling main body; a plurality of input taper portions which are tapered input ports, wherein the plurality of input taper portions are disposed on an input side of the optical coupling main body and a width of each of the plurality of input taper portions becomes narrower as it is away from a connection end with the optical coupling main body; and one output taper portion which is a tapered output port, wherein the output taper portion is disposed on an output side of the optical coupling main body and a width of the output taper portion becomes narrower as it is away from a connection end with the optical coupling main body; wherein the width of a connection end of the output taper portion with the optical coupling main body is wider than the width of any one of connection ends of the plurality of input taper portions with the optical coupling main body.

According to a second aspect of the present disclosure, in the optical coupler of the first aspect, the optical coupler may be a 3-input and 1-output type or a 2-input and 1-output type.

According to a third aspect of the present disclosure, in the optical coupler of the first or second aspect, all of the plurality of different wavelengths may be visible light wavelengths.

According to a fourth aspect of the present disclosure, in the optical coupler of the third aspect, the visible light wavelengths may be a red wavelength of 610 nm or more and 750 nm or less, a green wavelength of 500 nm or more and 560 nm or less, and a blue wavelength of 435 nm or more and 480 nm or less.

According to a fifth aspect of the present disclosure, in the optical coupler of the first aspect, the optical coupling main body may have a first MMI type optical coupling main body and a second MMI type optical coupling main body which are connected from the input side, the width of the second MMI type optical coupling main body may be narrower than the width of the first MMI type optical coupling main body, the plurality of input taper portions may be provided on the input side of the first MMI type optical coupling main body, and the output taper portion may be provided on the output side of the second MMI type optical coupling main body.

According to a sixth aspect of the present disclosure, in the optical coupler of the fifth aspect, a connection portion of the second MMI type optical coupling main body with the first MMI type optical coupling main body may have a width changing portion that becomes wider as it approaches the first MMI type optical coupling main body.

According to a seventh aspect of the present disclosure, in the optical coupler of any one of the first to fourth aspects, the optical coupler may further include a substrate made of a material different from lithium niobate, and an optical coupling functional layer formed on a main surface of the substrate and made of a lithium niobate film, wherein the optical coupler is formed in an optical coupling functional layer.

According to an eighth aspect of the present disclosure, in the optical coupler of the fifth or sixth aspect, the optical coupler may further include a substrate made of a material different from lithium niobate, and an optical coupling functional layer made of a lithium niobate film formed on the main surface of the substrate, wherein the optical coupler is formed in an optical coupling functional layer.

A ninth aspect of the present disclosure is a visible light source module including the optical coupler according to any one of the first to eighth aspects, and a plurality of visible laser light sources configured to emit visible lights that are coupled by the optical coupler.

A tenth aspect of the present disclosure is an optical coupler with an optical modulation function, including the optical coupler according to any one of the first to eighth aspects, and a Mach-Zehnder type optical modulator connected to the optical coupler and configured to guide a plurality of visible lights emitted from a plurality of visible laser light sources to the optical coupler.

An eleventh aspect of the present disclosure is a visible light source module including the optical coupler with a light modulation function according to the tenth aspect, and a plurality of visible laser light sources configured to emit visible lights that are coupled by the optical coupler with a light modulation function.

A twelfth aspect of the present disclosure is an optical engine including the visible light source module according to any one of the ninth or eleventh aspect, and a light scanning mirror that reflects the light emitted from the visible light source module by changing an angle to display an image.

According to the present disclosure, it is possible to provide an optical coupler that can be connected or integrated with an optical modulator using a lithium niobate film and can be made smaller than conventional ones.

### BRIEF DESCRIPTION OF THE DRAWINGS

FIG. 1 is a schematic plan view of an optical coupler according to a first embodiment.

FIG. 2 is a schematic plan view of an optical coupler according to a second embodiment.

FIG. 3 is a diagram showing effects of the present disclosure.

FIG. 4A is a diagram showing a principle of an MMI type optical coupler, and is a diagram showing a relationship between a width W_{M} and an effective width Wₑ of the optical coupler, and a single mode and a high order mode.

FIG. 4B is a diagram showing the principle of the MMI type optical coupler, and is a diagram showing simulation results of electromagnetic field distribution in a cross section of a waveguide in each of a single mode (TM0), a high order mode (TM1), and a high order mode (TM2).

FIG. 5A is a diagram showing the principle of the MMI type optical coupler, and shows results of a simulation of the electromagnetic field distribution of red (R) light.

FIG. 5B is a diagram showing the principle of the MMI type optical coupler, and shows results of a simulation of the electromagnetic field distribution of green (G) light.

FIG. 6 is a graph showing a relationship between the length of an optical coupling main body and the beat length and the output intensity for each of red (R) and green (G) laser lights.

FIG. 7 is a schematic plan view of an optical coupler according to a third embodiment.

FIG. 8A is a graph showing a relationship between the length of a first MMI type optical coupling part (a first stage) and the beat length and the output intensity for each of red (R) and green (G) laser lights.

FIG. 8B is a graph showing a relationship between the length of a second MMI type optical coupler (a second stage) and the beat length and the output intensity for each of red (R) and green (G) laser lights.

FIG. 9 is a schematic plan view of another example of the optical coupler according to the third embodiment.

FIG. 10 is a schematic cross-sectional view taken along line X-X′ in FIG. 2 of an optical coupler according to a fourth embodiment in which constituent elements of the optical coupler according to the second and third embodiments are formed in an optical coupling functional layer made of lithium niobate.

FIG. 11 is a schematic cross-sectional view taken along a YZ plane when the MMI type optical coupling part has a trapezoidal cross section.

FIG. 12 is a schematic cross-sectional view taken along the YZ plane when the MMI type optical coupling part has a slab portion on the substrate side.

FIG. 13 is a schematic cross-sectional view taken along the YZ plane when the MMI type optical coupling part has a trapezoidal cross section and has a slab portion on the substrate side.

FIG. 14 is a schematic plan view of an optical coupler according to a fifth embodiment.

FIG. 15 is a schematic plan view of an optical coupler according to a sixth embodiment.

FIG. 16 is a schematic plan view of a visible light source module according to a first embodiment.

FIG. 17 is a schematic plan view of a visible light source module according to a second embodiment.

FIG. 18 is a schematic plan view of a visible light source module according to a third embodiment.

FIG. 19 is a schematic plan view of a visible light source module according to a fourth embodiment.

FIG. 20 is a conceptual diagram showing an optical engine according to the present embodiment.

### DETAILED DESCRIPTION OF THE INVENTION

Hereinafter, embodiments will be described in detail with reference to the drawings as appropriate. In the drawings used in the following description, characteristic parts may be shown to be enlarged for convenience in order to make the characteristics easier to understand, and dimensional ratios of each of components may be different from actual ones. Materials, dimensions, and the like exemplified in the following description are merely examples, and the present disclosure is not limited thereto, and can be implemented with appropriate changes within the scope of achieving the effects of the present disclosure.

### Optical Coupler (First Embodiment)

FIG. 1 is a schematic plan view showing an optical coupler according to a first embodiment.

The optical coupler 100 shown in FIG. 1 is a multimode interference type optical coupler that couples laser lights of two different wavelengths. The optical coupler 100 includes an optical coupling main body (hereinafter, sometimes referred to as “MMI type optical coupling main body”) 50, two input taper portions 50-1 and 50-2 which are tapered input ports that are disposed on the input side of the optical coupling main body 50, and one output taper portion 52 which is a tapered output port that is disposed on the output side of the optical coupling main body 50. Furthermore, the width of each two input taper portions 50-1 and 50-2 becomes narrower as each two input taper portions 50-1 and 50-2 is away from a connection end with the optical coupling main body 50; and the width of the output taper portion 52 becomes narrower as the output taper portion 52 is away from the connection end with the optical coupling main body 50. Furthermore, in the optical coupler 100, a width Wout of a connection end 52A of the output taper portion 52 with the optical coupling main body 50 is wider than widths W1in and W2in of connection ends 50-1A and 50-2A of the two input taper portions 50-1 and 50-2 with the optical coupling main body 50.

In the following, the width of the connection end of the output taper portion with the optical coupling main body may be simply referred to as “the width of the output taper portion,” and similarly, the width of the connection end of the input taper portion with the optical coupling main body may be simply referred to as “the width of the input taper portion.”

The optical coupler 100 shown in FIG. 1 is a 2×1 (2-input and 1-output type) multimode interference (MMI) type optical coupler.

In FIG. 1, an X direction is a direction perpendicular to a side surface in which a light incidence port is disposed, a Y direction is a direction perpendicular to the X direction, and a Z direction is a direction perpendicular to a plane formed by the X direction and the Y direction.

Waves shown inside the optical coupling main body 50 in FIG. 1 conceptually represent multimode interference.

A first optical input-side optical waveguide 21-1 and a second optical input-side optical waveguide 21-2 respectively connected to two light incidence ports (a first light incidence port 21-1i and a second light incidence port 21-2i) provided in the first side surface 100A are connected to the optical input side of the optical coupling main body 50 via each of the input taper portion 50-1 and 50-2.

On the other hand, an optical output-side optical waveguide 22 connected to one light emission port 220 provided in a third side surface 100C is connected to the optical output side of the optical coupling main body 50 via the output taper portion 52.

The optical coupler 100 shown in FIG. 1 is configured to have two input taper portions corresponding to the input laser lights of two different wavelengths, but the present disclosure is not limited to two input taper portions, and three or fourth or more input taper portions may be provided.

Further, the optical coupler 100 shown in FIG. 1 has a configuration in which four side surfaces 100A, 100B, 100C and 100D are provided, two light incidence ports are provided in the first side surface 100A, and one light emission port is provided in the third side surface 100C, but the one light emission port may be provided in the second side surface 100B or the fourth side surface 100B.

The two wavelengths may be different visible light wavelengths.

### Optical Coupler (Second Embodiment)

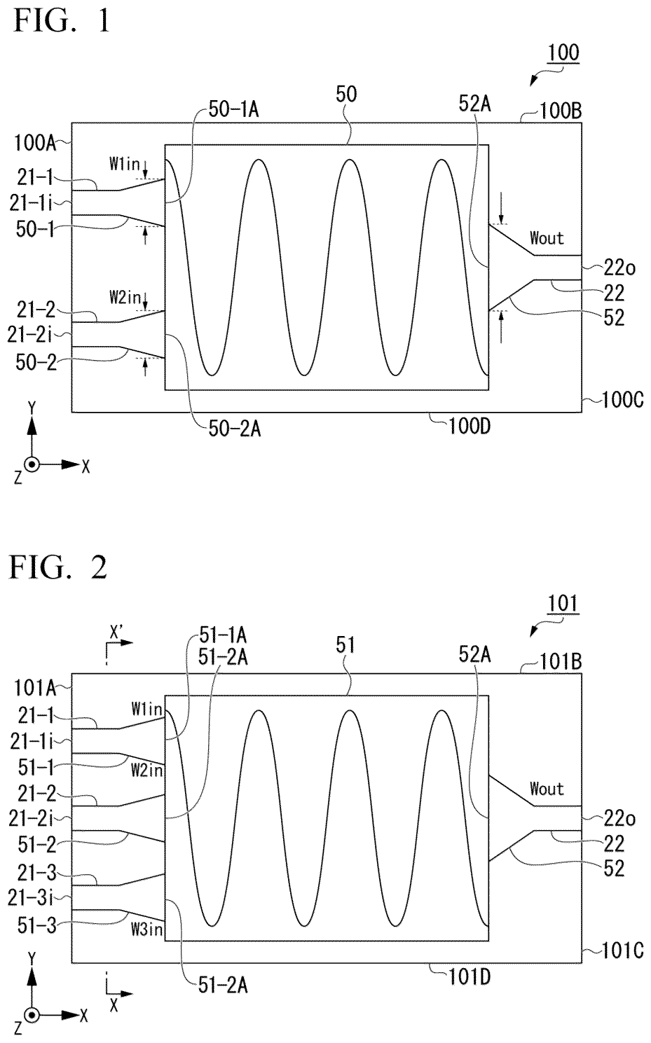

The optical coupler 101 shown in FIG. 2 is a multi-mode interference type optical coupler that couples laser lights of three different wavelengths. The optical coupler 101 includes an optical coupling main body 50, three input taper portions 51-1, 51-2 and 51-3 which are tapered input ports that are disposed on the input side of the optical coupling main body 50, and one output taper portion 52 which is a tapered output port that is disposed on the output side of the optical coupling main body 51. Furthermore, the width of each of the three input taper portions 51-1, 51-2 and 51-3 becomes narrower the further away from the connection end with the optical coupling main body 50, and the width of the output taper portion 52 becomes narrower as it is away from the connection end with the optical coupling main body 51. Furthermore, in the optical coupler 101, a width Wout of a connection end 52A of the output taper portion 52 with the optical coupling main body 51 is wider than widths W1in, W2in and W3in of connection ends 51-1A, 51-2A and 51-3A of the three input taper portions 51-1, 51-2 and 51-3 with the optical coupling main body 51.

The optical coupler 101 shown in FIG. 2 is a 3×1 (3-input and 1-output type) multimode interference (MMI) type optical coupler.

A first optical input-side optical waveguide 21-1, a second optical input-side optical waveguide 21-2 and a third optical input-side optical waveguide 21-3 respectively connected to three light incidence ports (a first light incidence port 21-1i, a second light incidence port 21-2i and a third light incidence port 21-3i) provided in a first side surface 101A are connected to the optical input side of the optical coupling main body 51 via the input taper portions 51-1, 51-2 and 51-3.

On the other hand, an optical output-side optical waveguide 22 connected to one light emission port 220 provided in the third side surface 101C is connected to the optical output side of the optical coupling main body 51 via the output taper portion 52.

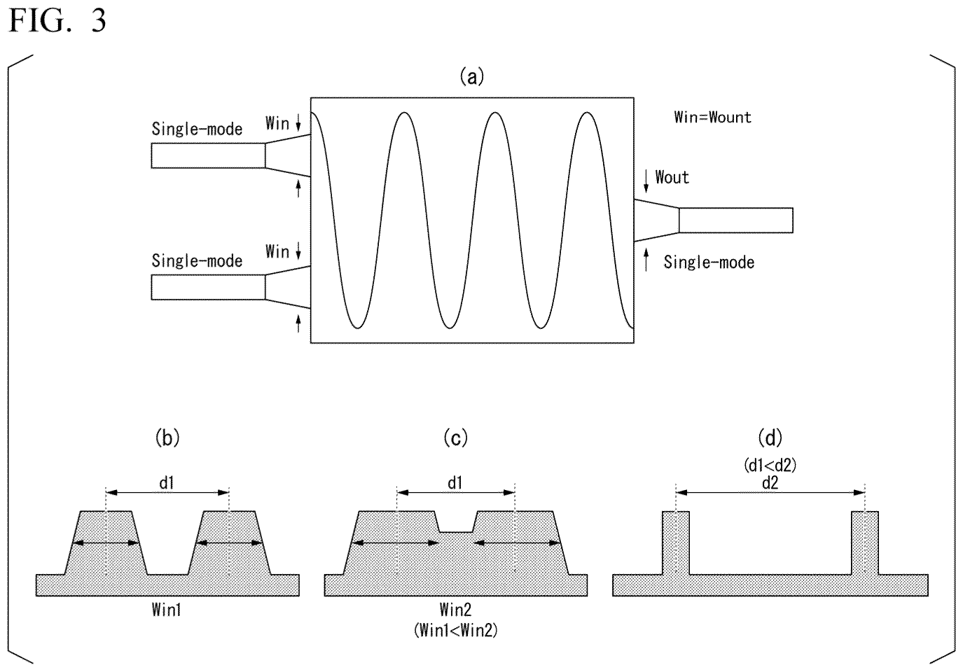

Effects of the present disclosure will be described using FIG. 3.

In FIG. 3, (a) is the optical coupler according to the first embodiment shown on the upper side. Shown below, in order from the left, (b) is a case of the optical coupler of the present disclosure in which the width W1in of the connection end 50-1A of the first input taper portion 50-1 and the width W2in of the connection end 50-2A of the second input taper portion 50-2 are appropriate dimensions, (c) next (the center) is a case in which the width W1in and the width W2in are too wide, and (d) next (the right) is a case in which the input port does not have a taper.

The reason why the taper portion is provided in the input and output ports connected to the optical coupling main body is as follows. The optical input-side optical waveguide and the optical output-side optical waveguide connected to the optical coupling main body are set so that laser light in a single mode (a zero-order mode, a fundamental mode) propagates, and the optical coupling main body is set so that laser light in a multimode (from the zero-order mode to a high order mode) propagates. Therefore, when light is input from the optical input-side optical waveguide to the optical coupling main body, and when light is output from the optical coupling main body to the optical output-side optical waveguide, coupling loss occurs due to mode mismatch between the single mode that is incident and the multimode. On the other hand, when the taper portions are provided at the input and output ports, the mode mismatch between the input single mode that is incident and the multimode is alleviated, and the coupling loss is reduced. As the width of the taper portion is sufficiently wide, the mode mismatch will be further alleviated, and the coupling loss will be further reduced. This effect is not affected by adjacent output ports because there is only one output port on the output port side and there are no adjacent output ports.

On the other hand, since a plurality of input ports are provided on the input port side, when the width of the taper portion provided on each of the input ports is too wide (when the width is Win2 in FIG. 3), a groove between the adjacent input taper portions are filled, resulting in insufficient separation and increased coupling loss. Therefore, the width of the input taper portion cannot be made sufficiently larger than the width of the output taper portion.

On the other hand, when a distance between the adjacent input taper portions is increased (when the distance is d2 in FIG. 3) in order to reduce the coupling loss as much as possible, the groove is not filled, and a cross section of a ridge becomes rectangular, which reduces the coupling loss, but the width of the optical coupling main body is also increased, resulting in a problem of an increase in the length of the optical coupling main body.

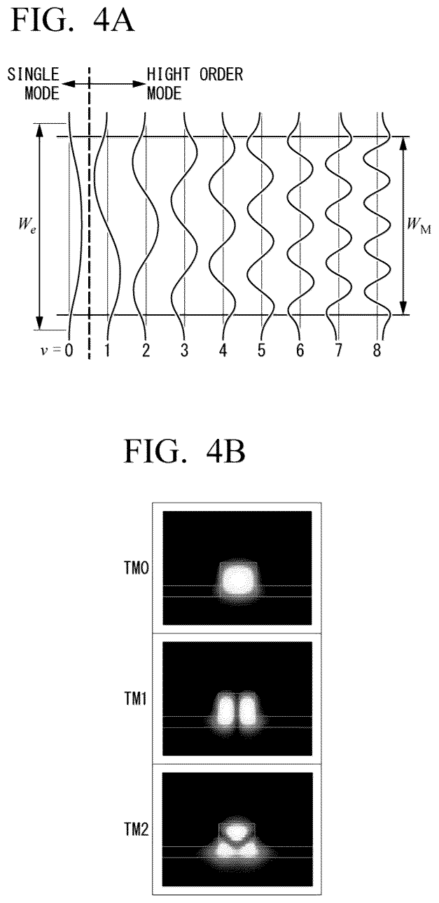

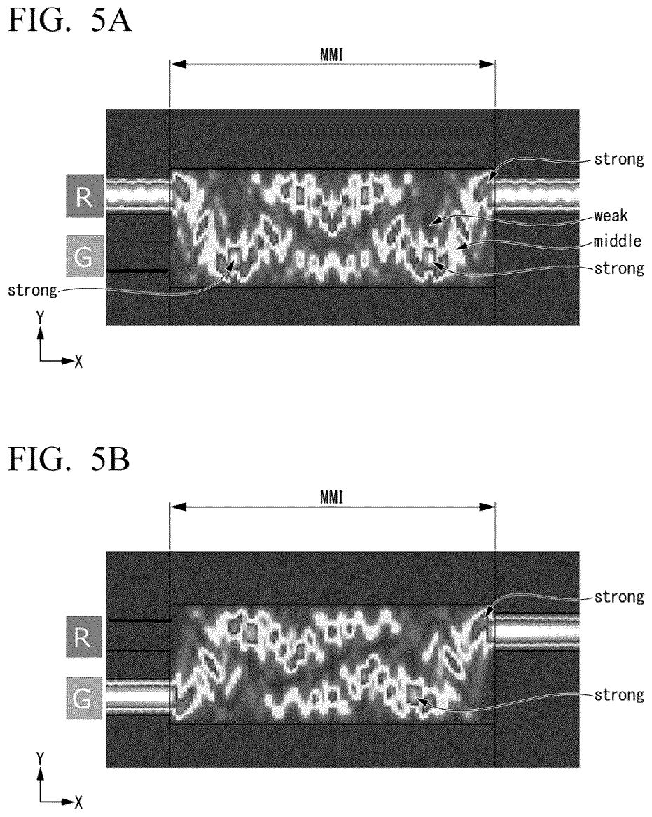

The reason why the length of the optical coupling main body increases as the width of the optical coupling main body increases will be described using FIGS. 4A and 4B and FIGS. 5A and 5B.

FIG. 4A shows a single mode (v=0) and a high order mode (v=1) occurring in the width W_{M} of the MMI type optical coupler. We is an effective width of the MMI type optical coupler, and is approximated by an effective width of the MMI type optical coupler in consideration of seepage of the optical mode and Goose-Henschen shift in the zero-order mode (the fundamental mode). FIG. 4B is a diagram showing simulation results of electromagnetic field distribution in a cross section of the waveguide in each of the single mode (TM0), the high order mode (TM1) and the high order mode (TM2).

In the MMI type optical coupler, there are characteristics in which a plurality of modes from the zero-order mode to the high order mode interfere with each other, and an image is formed (converged) at a specific position (a predetermined distance from an input end) of the MMI type optical coupler. It is known that a distance or period (the beat length) Lπ between adjacent convergence points approximately follows Equation (1). Equation (1) is the beat length Lπ between the two low-order modes including the zero-order mode and the first-order mode.

$$[ Equation 1 ]$$

$${L}_{π} = \frac{π}{{β}_{0} - {β}_{1}} ≅ \frac{4 {nW}_{e}^{2}}{3 λ} \qquad ( 1 )$$

In Equation (1), We is an effective width of the MMI type optical coupler, n is an effective refractive index of the MMI type, and λ is the wavelength of input light. β₀ and β₁ are propagation constants of the zero-order mode and the first-order mode, respectively. From Equation (1), it can be understood that the beat length Lx depends on the width and wavelength of the MMI type optical coupler.

For each wavelength, the beat length Lπ increases in proportion to the square of the width of the MMI type optical coupler. Therefore, when the width of the optical coupling main body increases, the length of the optical coupling main body will increase.

When the electromagnetic field distribution undergoes a 2π phase change in all propagation modes generated within the MMI type optical coupler, light intensity distribution matches incident light intensity distribution. The light propagation distance required until the matching (converging) state is achieved is called a self-projection distance, and convergence is repeated at a period of La after a certain propagation distance of 3Lπ/4.

FIGS. 5A and 5B show results of a simulation using simulation software (Fimmwave created by Photon Design Co.) regarding the electromagnetic field distribution in a cross section of a 2×1 MMI type optical coupler (R/G coupler) in a light propagation direction (an x direction). In a simulation model, the position (coordinates) in a y direction of the input-side waveguide through which red (R) light with a wavelength of 638 nm is input to the optical coupler is the same as the position (coordinates) in the y direction of the output-side waveguide of the optical coupler, and a position in the y direction of the input-side waveguide through which green (G) light with a wavelength of 520 nm is input to the optical coupler is separated by a predetermined distance. Lighter colored portions indicate positions in which the respective modes are strongly interfering with each other (“string” in the drawing), darker colored portions indicate positions in which the respective modes are not strongly interfering with each other (“weak” in the drawing), and intermediate colored portions indicate positions in which the degree of interference between the modes is intermediate (“middle” in the drawing).

FIG. 5A shows results of performing a simulation of the electromagnetic field distribution of red (R) light, and FIG. 5B shows the result of performing a simulation of the electromagnetic field distribution of green (G) light.

In both FIGS. 5A and 5B, preferably, the length (the length in the X direction) of the MMI type optical coupler is set so that the optical coupler has a strongly interfering portions near the output port, and positions thereof match each other as much as possible (that is, they are as close to an integer multiple (least common multiple) of the beat length of each input wavelength as possible). In this way, the length of the MMI type optical coupler is set, but the premise is the beat length Lx for each wavelength, and since the beat length La increases in proportion to the square of the width of the MMI type optical coupler, as the width of the optical coupling main body increases, the length of the optical coupling main body increases.

Since a phase difference according to an input position of each input wavelength to the optical coupler is affected, the length of the MMI type optical coupler cannot be determined only by an integral multiple of the beat length of each input wavelength.

Therefore, the length of the optical coupler is initially set to be an integral multiple (least common multiple) of the beat length of each input wavelength, and has to be adjusted in consideration of the influence of the phase according to the input position of each input wavelength to the optical coupler.

Laser light of three different wavelengths may be visible lasers.

For example, laser lights of three different wavelengths may be a red laser light with a red (R) wavelength of 610 nm or more and 750 nm or less, a green laser light with a green (G) wavelength of 500 nm or more and 560 nm or less, and a blue laser light with a blue (B) wavelength of 435 nm or more and 480 nm or less.

In a state in which the input positions of the red and green laser lights are symmetrical with respect to the center of the optical coupler in a direction (the y direction) perpendicular to the light propagation direction, and the phases of the red and green laser lights are aligned, integral multiples of the beat lengths of the red and green laser lights are set as starting points for adjusting the length of the optical coupler, and then the length of the optical coupler may be adjusted on the basis of the beat length of blue laser light so that an output of the blue laser light can also be increased.

In this way, for the arrangement of input ports of RGB laser lights, preferably, the red (R) and green (G) laser lights are positioned symmetrically with respect to the center in the direction (the y direction) perpendicular to the light propagation direction, and the blue (B) laser light is disposed at a center position.

For the arrangement of the input ports of the RGB laser lights, in a case in which a dimension of the MMI type optical coupler with two colors of red and green having a light intensity of 0.3 or more for both colors are calculated from the least common multiple of the beat length Lx, and the blue light intensity is calculated by fixing the MMI type optical coupler to the calculated dimension, when blue is disposed at the center position, the light intensity of each of red, green and blue is maximized, and the dimension of the MMI type optical coupler can be designed to be short, and thus this arrangement has the smallest coupling loss.

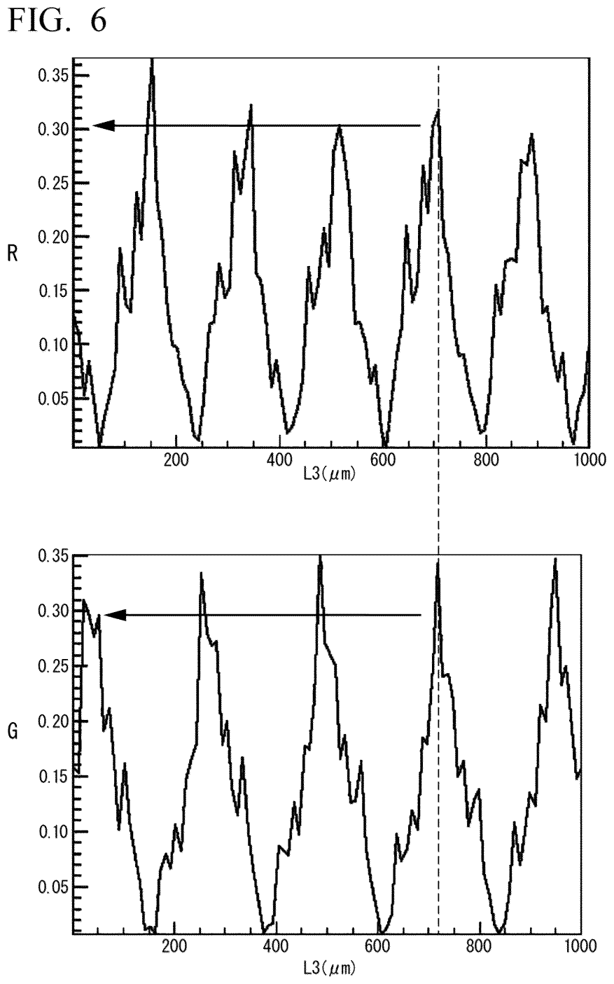

FIG. 6 is a graph showing a relationship between the length of the MMI type optical coupling main body and the beat length and the output intensity for each of red (R) and green (G) laser lights. The horizontal axis is the length of the MMI type optical coupler, and the vertical axis is the light intensity.

The beat lengths of red (R) and green (G) are different. When the length of the MMI type optical coupling main body is approximately 700 μm, both red (R) and green (G) can be coupled with an output intensity of 0.3. At this time, red (R) is almost at the peak, and green (G) is just before the peak. At this time, when the width of the taper on the output side is widened, the output of the green (G) is improved.

### Optical Coupler (Third Embodiment)

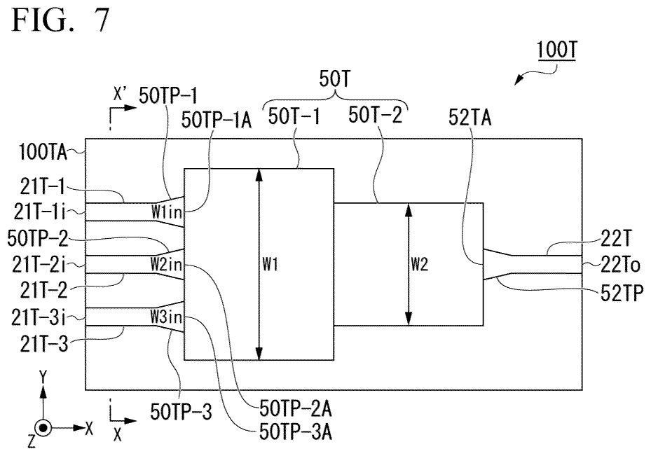

FIG. 7 is a schematic plan view showing an optical coupler according to a third embodiment.

The optical coupler according to the third embodiment is different from the optical coupler according to the above embodiment in that the optical coupling main body in the above embodiment is configured with two stages.

The optical coupler 100T shown in FIG. 7 is an optical coupler that couples laser lights of three different wavelengths. The optical coupler 100T includes a two-stage MMI type optical coupling main body 50T in which a first MMI type optical coupling main body 50T-1 and a second MMI type optical coupling main body 50T-2 are connected in this order from the input side, wherein a width W2 of the second MMI type optical coupling main body 50T-2 is narrower than a width W1 of the first MMI type optical coupling main body 50T-1. The optical coupler 100T shown in FIG. 7 includes three input taper portions 50TP-1, 50TP-2 and 50TP-3 which are tapered input ports that are disposed on the input side of the first MMI type optical coupling main body 50T-1 and one output taper portion 52TP which is a tapered output port that is disposed on the output side of the second MMI type optical coupling main body 50T-2. Furthermore, the width of each of three input taper portions 50TP-1, 50TP-2 and 50TP-3 becomes narrower as each of three input taper portions 50TP-1, 50TP-2 and 50TP-3 is away from a connection end with the first MMI type optical coupling main body 50T-1; and the width of the output taper portion 52TP becomes narrower as the output taper portion 52TP is away from a connection end with the second MMI type optical coupling main body 50T-2.

In the optical coupler 100T shown in FIG. 7, a width Wout of a connection end 52TA of the output taper portion 52TP with the second MMI type optical coupling main body 50T-2 is wider than widths W1in, W2in and W3in of the connection ends 50TP-1A, 50TP-2A and 50TP-3A of three input taper portions 50TP-1, 50TP-2 and 50TP-3 with the first MMI type optical coupling main body 50T-1.

A first optical input-side optical waveguide 21T-1, a second optical input-side optical waveguide 21T-2 and a third optical input-side optical waveguide 21T-3 connected to each of three light incidence ports (a first light incidence port 21T-1i, a second light incidence port 21T-2i and a third light incidence port 21T-3i) provided in a first side surface 100TA are connected to the optical input side of the first MMI type optical coupling main body 50T-1 via input taper portions 50TP-1, 50TP-2 and 50TP-3.

On the other hand, a first optical output-side optical waveguide 22 connected to one light emission port 22To is connected to the optical output side of the second MMI type optical coupling main body 50T-2 via an output taper portion 52TP.

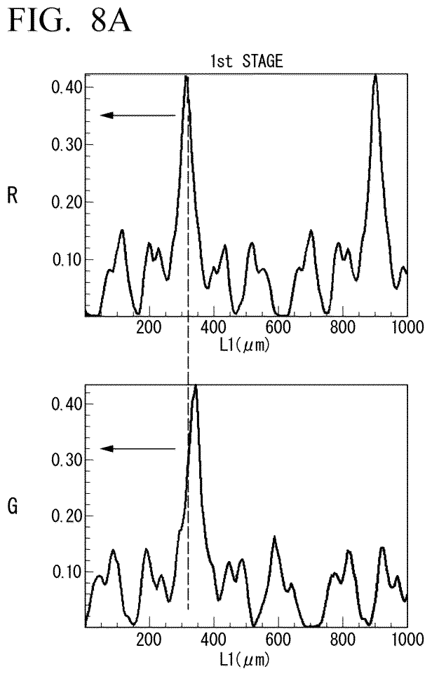

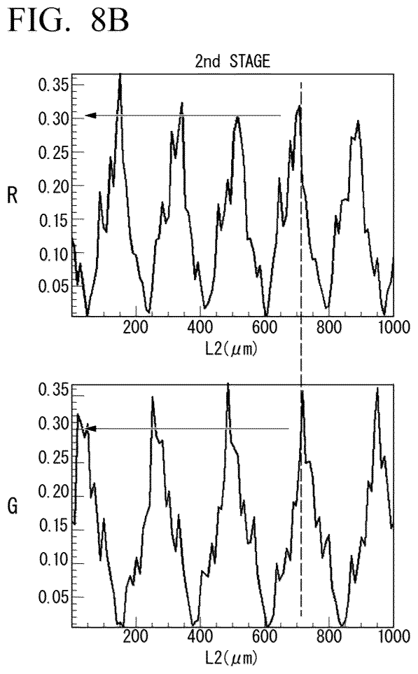

FIGS. 8A and 8B are graphs showing a relationship between the length of each of the first MMI type optical coupling main body (the first stage) and the beat length and the second MMI type optical coupling main body (the second stage) and the output intensity for red (R) and green (G) laser lights. The horizontal axis is the length of the MMI type optical coupling main body, and the vertical axis is the light intensity.

The beat lengths of red (R) and green (G) are different. When the length of the first MMI type optical coupling main body is approximately 300 μm and the length of the second MMI type optical coupling main body is approximately 700 μm, both red (R) and green (G) can be coupled with an output intensity of 0.3. At this time, red (R) is almost at the peak, and green (G) is just before the peak. At this time, increasing the width of the taper on the output side improves the output of green (G).

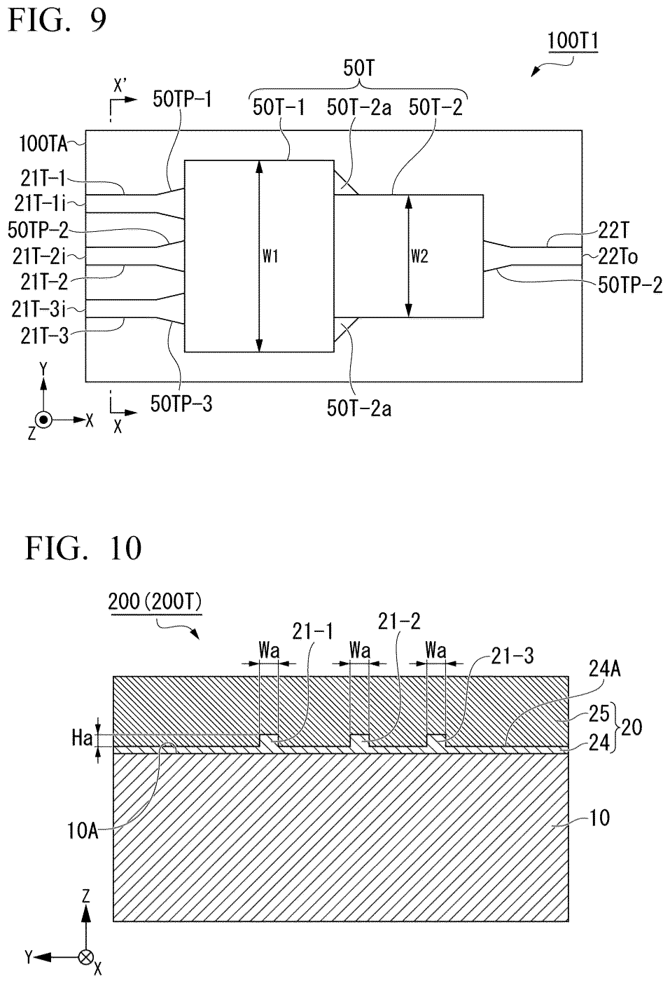

FIG. 9 is a schematic plan view showing a modified example of the optical coupler according to the third embodiment.

The optical coupler 100T1 shown in FIG. 9 is different from the optical coupler 100T1 shown in FIG. 7 in that a connection portion of the second MMI type optical coupling main body 50T-2 with the first MMI type optical coupling main body 50T-1 has a width changing portion 50T-2a which becomes wider as it approaches the first MMI type optical coupling main body 50T-1.

### Optical Coupler (Fourth Embodiment)

An optical coupler according to a fourth embodiment includes a substrate made of a material different from lithium niobate, and an optical coupling functional layer formed on a main surface of the substrate and made of a lithium niobate film, wherein the optical coupler according to the above embodiment is formed in the optical coupling functional layer. Regarding the constituent elements described below, constituent elements having the same functions as those in the above embodiment may be designated by the same reference numerals, and a description thereof may be omitted. Although the optical coupler 200 shown in FIG. 10 will be described using an example in which the optical coupler 101 shown in FIG. 2 is formed in the optical coupling functional layer, 200T in parentheses of the reference numeral 200 also includes a case in which the optical coupling main body has a two-stage structure (the third embodiment), for the sake of convenience.

FIG. 10 is a schematic cross-sectional view taken along a YZ plane (X-X′ in FIG. 2) of the optical coupler 200 in which the optical coupler 101 shown in FIG. 2 is formed in the optical coupling functional layer made of lithium niobate. The optical coupler 200 shown in FIG. 10 includes a substrate 10 made of a material different from lithium niobate, and an optical coupling functional layer 20 formed on a main surface of the substrate 10 and made of lithium niobate, wherein the light incidence port, the light emission port, the optical coupling main body, the input taper portion, the output taper portion, the first optical input-side optical waveguide, the second optical input-side optical waveguide, the third optical input-side optical waveguide and the output-side optical waveguide are formed in the optical coupling functional layer 20.

In the optical coupler 200, in a case in which a difference in refractive index between a waveguide core film and a waveguide cladding film is Δn, when the waveguide core film is made of lithium niobate, Δn can be designed to be a larger value than when a material such as glass is used, a radius of curvature of the optical waveguide can be reduced, and an increase in the coupling length can be prevented compared to in a case of using a directional coupler by using the multimode interference type optical coupling part, and thus it is possible to achieve both improved design freedom and miniaturization.

The optical coupling functional layer 20 is configured of a waveguide core film 24 made of a lithium niobate film in which the light incidence port, the light emission port, the optical coupling main body, the input taper portion, the output taper portion, the first optical input-side optical waveguide, the second optical input-side optical waveguide, the third first optical input-side optical waveguide and the output-side optical waveguide are formed, and a waveguide cladding (buffer) film 25 formed on the waveguide core film 24 so as to cover them. Hereinafter, the reference numeral 24 may be used for the lithium niobate film.

Examples of the substrate 10 include a sapphire substrate, a Si substrate, and a thermally oxidized silicon substrate.

Since the optical coupling functional layer 20 is made of a lithium niobate (LiNbO₃) film, it is not particularly limited as long as it has a lower refractive index than that of the lithium niobate film, but as a substrate on which a single crystal lithium niobate film can be formed as an epitaxial film, a sapphire single crystal substrate or a silicon single crystal substrate is preferable. Although the crystal orientation of the single crystal substrate is not particularly limited, for example, since a c-axis oriented lithium niobate film has three-fold symmetry, it is desirable that the underlying single-crystal substrate has the same symmetry, and in the case of a sapphire single crystal substrate, a c-plane substrate is preferable, and in the case of a silicon single crystal substrate, a (111)-plane substrate is preferable.

The lithium niobate film is, for example, a c-axis oriented lithium niobate film. The lithium niobate film is, for example, an epitaxial film grown epitaxially on the substrate 10. The epitaxial film is a single crystal film of which a crystal orientation is aligned by the underlying substrate. The epitaxial film is a film that has a single crystal orientation in a z direction and an in-plane direction of an xy plane, and crystals thereof are aligned in x-axis, y-axis and z-axis directions. Whether or not the film formed on the substrate 10 is an epitaxial film can be verified, for example, by checking a peak intensity and a polar point at an alignment position in 2θ-θ X-ray diffraction.

Specifically, when measurement is performed by the 2θ-θ X-ray diffraction, all peak intensities other than a target plane are 10% or less, preferably 5% or less of the maximum peak intensity of the target plane. For example, when the lithium niobate film is a c-axis oriented epitaxial film, the peak intensity other than a (00L) plane is 10% or less, preferably 5% or less of the maximum peak intensity of the (00L) plane. Here, (00L) is a general term for equivalent surfaces such as (001) and (002).

Further, in conditions for confirming the peak intensity at the orientation position described above, only orientation in one direction is indicated. Therefore, even in the case in which the above-described conditions are obtained, when the crystal orientation is not aligned within the plane, intensity of the X-rays will not increase at a specific angular position, and no pole point will be observed. For example, when the lithium niobate film is a lithium niobate film, since LiNbO₃ has a trigonal crystal structure, LiNbO₃ (014) in the single crystal has three pole points. In the case of lithium niobate, it is known that epitaxial growth occurs in a so-called twin crystal state in which crystals rotated by 180° around the c-axis are symmetrically coupled. In this case, two of the three pole points are symmetrically connected, and thus there are six pole points. Furthermore, when a lithium niobate film is formed on a (100) plane silicon single crystal substrate, 4×3=12 pole points are observed because the substrate has a four-fold symmetry. In the present disclosure, the lithium niobate film epitaxially grown in the twin crystal state is also included in the epitaxial film.

The composition of lithium niobate is LiₓNbA_{y}O_{z}. A is an element other than Li, Nb, and O. x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. The element of A includes, for example, K, Na, Rb, Cs, Be, Mg, Ca, Sr, Ba, Ti, Zr, Hf, V, Cr, Mo, W, Fe, Co, Ni, Zn, Sc, and Ce, and two or more of these elements may be combined.

Further, the lithium niobate film may be a lithium niobate single crystal thin film bonded onto a substrate.

A thickness of the lithium niobate film is, for example, 2 μm or less. The thickness of the lithium niobate film refers to a thickness of a portion other than a ridge. The thickness of the lithium niobate film may be optimally designed according to the wavelength used, the shape of the ridge, or the like.

The waveguide is a ridge protruding from a first surface 24A of the lithium niobate film 24. The first surface 24A is an upper surface of a portion (a slab layer) of the lithium niobate film 24 other than the ridge.

As shown in FIG. 10, a cross-sectional shape of a regular cross-sectional shape portion of each of the first optical input-side optical waveguides 21-1, the second optical input-side optical waveguides 21-2 and the third optical input-side optical waveguides 21-3 is rectangular, but any shape that can guide light may be used, for example, it may have a trapezoidal shape, a triangular shape, a semicircular shape, or the like. The width Wa of three ridges in the y direction is preferably 0.2 μm or more and 5.0 μm or less, and a height of each of the three ridges (a protrusion height Ha from the first surface 24A) is preferably, for example, 0.1 μm or more and 1.0 μm or less. The same applies to other optical waveguides.

Propagation into a single mode can be achieved by setting a size of each of the first optical input-side optical waveguide 21-1, the second optical input-side optical waveguide 21-2, the third optical input-side optical waveguide 21-3 and other optical waveguides shown in FIG. 2 approximately to the wavelength of the laser light.

### <MMI Type Optical Coupling Main Body>

(1) MMI Type Optical Coupling Main Body with Trapezoidal Cross Section

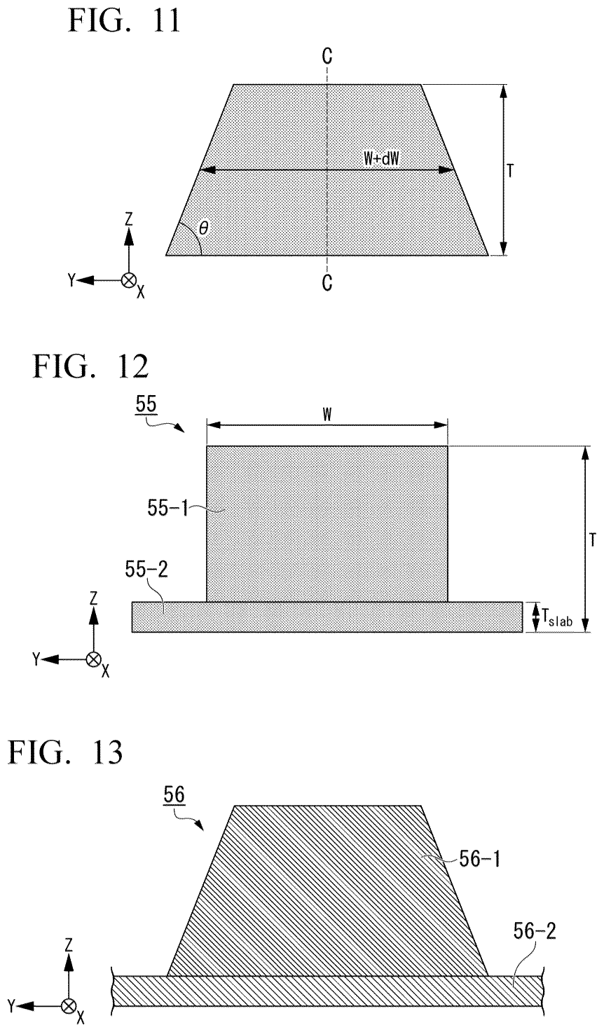

The MMI type optical coupling main body may preferably have a trapezoidal cross section taken in a direction perpendicular to a traveling direction of light, as shown in FIG. 11. Further, preferably, an inclination angle θ of the trapezoidal shape may be 40° to 85°.

This is because the dimensional margin of a width W of the MMI type optical coupling main body is improved, the width of the optimal MMI type optical coupling main body is increased, and processing becomes easier.

This result was obtained by comparing the light propagation losses of the three colors of RGB through a simulation when the cross section of the MMI type optical coupling main body cut in the direction perpendicular to the traveling direction of light is trapezoidal, and when it is rectangular.

In a model used in this simulation, assuming that a height T of the MMI type optical coupling main body (a ridge) is 0.7 μm, and the width at ½ of the height T of the MMI type optical coupling main body is W, while a center C—C of the ridge is fixed and an inclination angle θ between a lower surface and an inclined portion is fixed, a simulation of the propagation loss during RGB coupling is performed by expanding or contracting it by dW/2 on both sides (therefore, dW in total).

In a 2×1 MMI type optical coupler that couples two colors of light, when 0 is 85°, 70° and 40°, the margins were all 0.3 μm, and the optimum widths W were 6.6 μm, 6.6 μm and 6.9 μm.

(2) MMI Type Optical Coupling Main Body with Slab Portion

The MMI type optical coupling main body may have a slab portion on the substrate side, as shown in FIG. 12. The MMI type optical coupling main body 55 shown in FIG. 12 has a ridge 55-1 and a slab portion 55-2 on the substrate side.

The width dimension margin may be further expanded by having the slab portion, and processing may be further facilitated. In addition, the optimum width W may be further expanded, and processing may be further facilitated. When the MMI type optical coupling main body has the configuration of the model shown in FIG. 12, a simulation of the propagation loss (dB) of the fundamental mode (TM0) and the high order modes (TM1 and TM2) of each of the three RGB colors during RGB coupling was performed. A height Tslab of the slab portion is 0.2 μm, and a height T of the MMI type optical coupling main body is the sum of the height of the ridge 55-1 and the height of the slab portion 55-2. The width W of the MMI type optical coupling main body is 6.5 μm.

For comparison, the light propagation loss in a case without the slab portion and in a case with the slab portion was compared, in the case with the slab portion, a difference in the propagation loss between RGB was reduced compared to the case without the slab portion. Furthermore, due to a difference in the propagation loss between the case with the slab portion and the case without the slab portion, the propagation loss of the high order modes was increased, resulting in curbed propagation. Therefore, it was understood that the case with the slab portion is effective for achieving the single mode.

Further, as shown in FIG. 13, the MMI type optical coupling main body 56 having a trapezoidal cross section may have a ridge 56-1 and further a slab portion 56-2 on the substrate side. Due to the slab portion being provided, the width dimension margin is further expanded, and the optimum width W is further expanded, which may further facilitate processing.

When the optical coupler according to the present disclosure is mounted in a glasses type terminal, dimensions thereof can be exemplified as follows.
[In the case of 3×1 MMI (1 stage) or 2×1 MMI (1 stage)]
Width of optical coupling main body: 1 to 1000 μm
Length of optical coupling main body: 10 to 10,000 m
Width Win of input taper portion: 0.2 to 5 μm
Width Wout of output taper portion: 0.2 to 10 μm (Wout=W1in+α (0 μm<α≤5 μm))
[In the case of 3×1 MMI (2 stages) or 2×1 MMI (2 stages)]
Width of the first stage optical coupling main body: 1 to 1000 μm
Width of the second stage optical coupling main body: 0.9 to 900 μm
Length of the first stage optical coupling main body: 50 to 1000 μm
Length of the second stage optical coupling main body: 50 to 2000 μm
Width Win of input taper portion: 0.2 to 5 μm
Width Wout of output taper portion: 0.2 to 10 μm (Wout=W1in+α (0 μm<α≤5 μm))

In the above, a configuration in which the widths of a plurality of input taper portions are the same is described as “Win.”

### Optical Coupler (Fifth Embodiment)

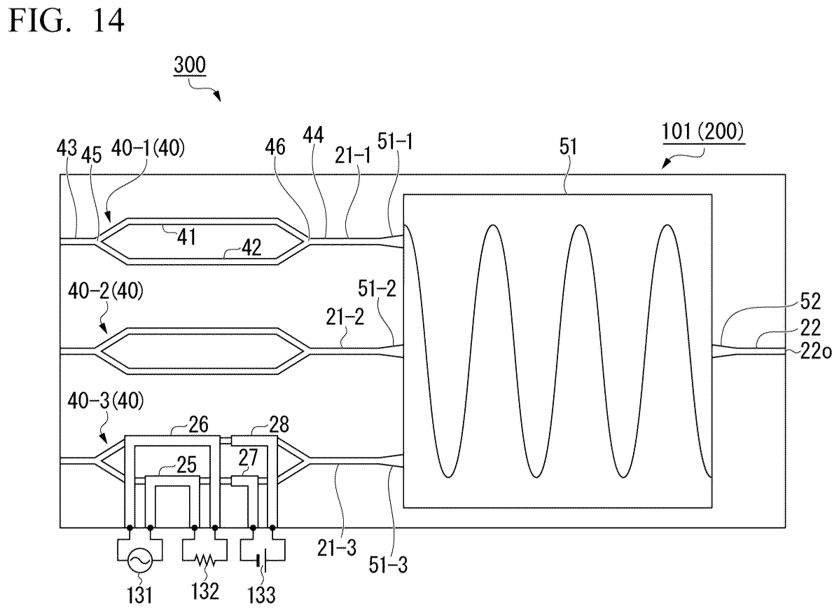

An optical coupler according to a fifth embodiment includes a substrate made of a material different from lithium niobate, and an optical coupling functional layer made of a lithium niobate film and formed on a main surface of the substrate, and the optical coupler according to the above embodiment and a Mach-Zehnder type optical modulator which is connected to the optical coupler and guides a plurality of visible lights emitted from a plurality of visible laser light sources to the optical coupler are integrated and formed in the optical coupling functional layer. Regarding constituent elements described below, the constituent elements having the same functions as those in the above embodiment may be designated by the same reference numerals, and a description thereof may be omitted. The optical coupler 300 with a light modulation function shown in FIG. 14 will be described by taking as an example a case in which the optical coupler 101 shown in FIG. 2 is formed in an optical coupling functional layer.

FIG. 14 is a schematic plan view of the optical coupler according to the fifth embodiment.

The optical coupler 300 shown in FIG. 14 includes a substrate 10 made of a material different from lithium niobate (refer to FIG. 10), and an optical coupling functional layer 20 made of a lithium niobate film and formed on a main surface of the substrate 10, wherein the optical coupler 300 with a light modulation function is formed in the optical coupling functional layer 20.

The optical coupler 300 with a light modulation function includes the optical coupler 101 shown in FIG. 2 and a Mach-Zehnder type optical modulator 40.

The Mach-Zehnder type optical modulator 40 includes three Mach-Zehnder type optical waveguides 40-1, 40-2 and 40-3, but two or four or more Mach-Zehnder type optical modulators 40 may be provided according to the number of input ports of the optical coupling main body 51.

A known Mach-Zehnder type optical modulator or an optical waveguide may be used as the Mach-Zehnder type optical modulator 40, and a light beam in which the wavelength and a phase are aligned is split (decoupled) into two pairs of beams, each given a different phase, and then merged (coupled). The intensity of the coupled light beam changes according to a difference in phase difference.

Each of the Mach-Zehnder type optical waveguides 40 (40-1, 40-2 and 40-3) shown in FIG. 14 includes a first optical waveguide 41, a second optical waveguide 42, an input path 43, an output path 44, a branching part 45, and a coupling part 46.

The first output path 44 of the Mach-Zehnder type optical waveguide 40-1 is connected to the input taper portion 51-1 of the optical coupling main body 51 and the first optical input-side optical waveguide 21-1. Further, the first output path 44 of the Mach-Zehnder type optical waveguide 40-2 is connected to the input taper portion 51-2 of the optical coupling main body 51 and the second optical input-side optical waveguide 21-2. Further, the first output path 44 of the Mach-Zehnder type optical waveguide 40-3 is connected to the input taper portion 51-3 of the optical coupling main body 51 and the third optical input-side optical waveguide 21-2.

Although the first optical waveguide 41 and the second optical waveguide 42 shown in FIG. 14 have a configuration in which they extend linearly in the x direction except for the vicinity of the branching part 45 and the vicinity of the coupling part 46, they are not limited to such a configuration. Lengths of the first optical waveguide 41 and the second optical waveguide 42 shown in FIG. 14 are approximately the same. The branching part 45 is located between the input path 43 and the first optical waveguide 41 and the second optical waveguide 42. The input path 43 is connected to the first optical waveguide 41 and the second optical waveguide 42 via the branching part 45. The coupling part 46 is located between the first optical waveguide 41 and the second optical waveguide 42 and the output path 44. The first optical waveguide 41 and the second optical waveguide 42 are connected to the output path 44 via the coupling part 46.

Electrodes 25 and 26 are electrodes that apply a modulation voltage to each of the Mach-Zehnder type optical waveguides 40-1, 40-2 and 40-3 (hereinafter, sometimes simply referred to as “each of the Mach-Zehnder type optical waveguides 40”). The electrode 25 is an example of a first electrode, and the electrode 26 is an example of a second electrode. One end of the electrode 25 is connected to a power source 131, and the other end is connected to a terminating resistor 132. One end of the electrode 26 is connected to the power source 131, and the other end is connected to the terminating resistor 132. The power source 131 is part of a drive circuit that applies a modulation voltage to each of the Mach-Zehnder type optical waveguides 40. The electrodes 25 and 26 are shown only in a portion of the Mach-Zehnder type optical waveguide 40-3 to simplify the drawing.

Electrodes 27 and 28 are electrodes that apply a DC bias voltage to each of the Mach-Zehnder type optical waveguides 40. One end of the electrode 27 and one end of the electrode 28 are connected to a power source 133. The power source 133 is part of a DC bias application circuit that applies a DC bias voltage to each of the Mach-Zehnder type optical waveguides 40.

When a DC bias voltage is superimposed on the electrodes 25 and 26, the electrodes 27 and 28 may not be provided. Further, a ground electrode may be provided around the electrodes 25, 26, 27 and 28.

### Optical Coupler (Sixth Embodiment)

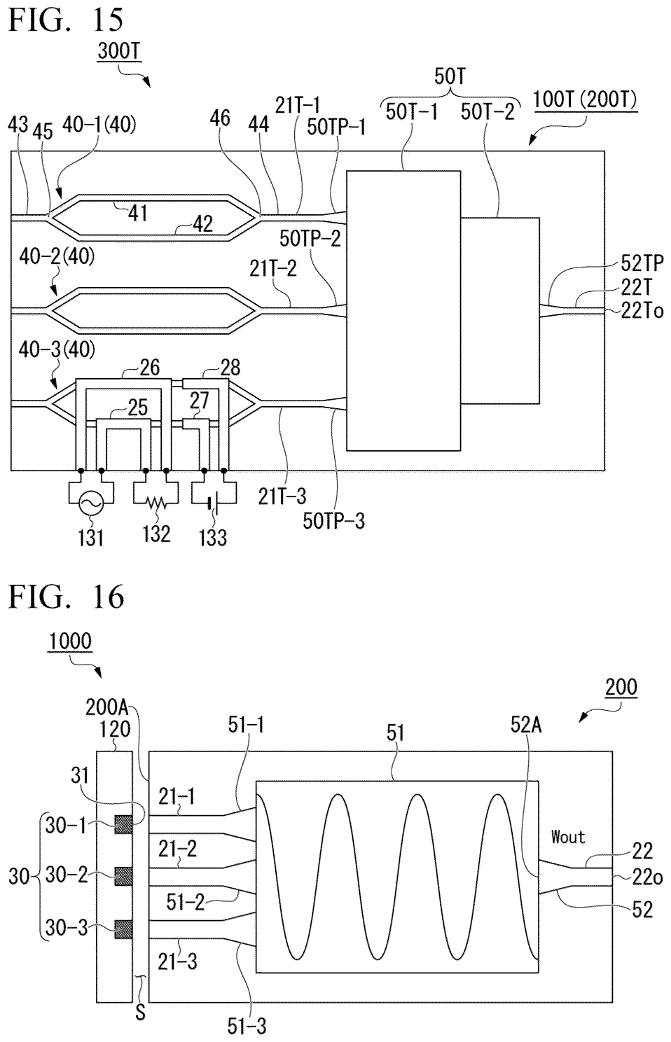

FIG. 15 is a schematic plan view showing an optical coupler according to a sixth embodiment.

The optical coupler according to the sixth embodiment is different from the optical coupler according to the fifth embodiment in that the optical coupling main body in the above embodiment is configured of two stages.

An optical coupler 300T with a light modulation function shown in FIG. 15 is a case in which the optical coupler 100T shown in FIG. 7 is formed in an optical coupling functional layer.

### Visible Light Source Module (First Embodiment)

A visible light source module according to a first embodiment includes the optical coupler according to this embodiment and a plurality of visible laser light sources which emit visible lights that are coupled by the optical coupler.

FIG. 16 is a schematic plan view of the visible light source module according to the first embodiment. FIG. 16 shows an example of a visible light source module including the optical coupler 200 shown in FIG. 10.

The visible light source module 1000 shown in FIG. 16 includes an optical coupler 200, and a plurality of visible laser light sources 30 (30-1, 30-2 and 30-3) that emit visible lights to be coupled by the optical coupler 200. The optical coupler 200 includes the substrate 10 (refer to FIG. 10) made of a material different from lithium niobate, and the optical coupling functional layer 20 (refer to FIG. 10) formed on a main surface of the substrate 10 and made of lithium niobate, and has a side surface 200A. The optical coupler included in the visible light source module 1000 shown in FIG. 16 may be the optical coupler 100.

Regarding the constituent elements shown in FIG. 16, the constituent elements having the same functions as those described above may be designated by the same reference numerals, and a description thereof may be omitted.

Various laser elements may be used as the visible laser light source 30. For example, commercially available laser diodes (LDs) emitting red light, green light, blue light, and the like may be used. Light with a peak wavelength of 610 nm or more to 750 nm or less may be used as red light, light with a peak wavelength of 500 nm or more and 560 nm or less may be used as green light, and light with a peak wavelength of 435 nm or more and 480 nm or less may be used as blue light.

In the visible light source module 1000, the visible laser light sources 30-1, 30-2 and 30-3 are an LD that emits green light, an LD that emits blue light, and an LD that emits red light. The LDs 30-1, 30-2 and 30-3 are disposed at an interval from each other in a direction substantially perpendicular to an emission direction of light emitted from each of the LDs and are provided on an upper surface of a subcarrier 120.

In the visible light source module 1000, the case in which the number of visible laser light sources is three has been exemplified, but the number of the visible laser light sources is not limited to three, and the number may be two or four or more. The plurality of visible laser light sources may all emit light of different wavelengths, or the plurality of visible laser light sources may emit light of the same wavelength. In addition, lights other than red (R), green (G), and blue (B) may be used for the emitted light, and a mounting order of red (R), green (G), and blue (B) described using the drawings is not necessarily in this order and may be changed as appropriate.

The LD 30 may be mounted on the subcarrier 120 as a bare chip. The subcarrier 120 is made of, for example, aluminum nitride (AlN), aluminum oxide (Al₂O₃), silicon (Si), or the like.

The subcarrier 120 may be directly bonded to the substrate 10 via a metal bonding layer. With such a configuration, further miniaturization is possible by not performing spatial coupling or fiber coupling.

A relative position between the subcarrier 120 and the substrate 10 may be adjusted during manufacturing by configuring the subcarrier 120 and the substrate 10 to be bonded via the metal bonding layer, and alignment of a position of an optical axis of visible laser light may be performed so that the optical axis of each optical laser matches respective axes of the first optical input-side optical waveguide 21-1, the second optical input-side optical waveguide 21-2, and the third optical input-side optical waveguide 21-3 (active alignment).

The three first optical input-side optical waveguide 21-1, second optical input-side optical waveguide 21-2 and third optical input-side optical waveguide 21-3 of the optical coupling main body 51 respectively face the emission ports of the LDs 30 (30-1, 30-2 and 30-3), and are positioned so that the light emitted from an emission surface of each of the LDs 30 can be incident on the first optical input-side optical waveguide 21-1, the second optical input-side optical waveguide 21-2 and the third optical input-side optical waveguide 21-3. The respective axes of the first optical input-side optical waveguide 21-1, the second optical input-side optical waveguide 21-2 and the third optical input-side optical waveguide 21-3 approximatively overlap the optical axis of the laser light emitted from the emission port of each of the LDs 30. Due to such a configuration and arrangement, blue light, green light, and red light emitted from the LDs 30-1, 30-2 and 30-3 can be incident on the three first optical input-side optical waveguides 21-1, second optical input-side optical waveguide 21-2 and third optical input-side optical waveguide 21-3 of the optical coupling main body 51.

A light emission surface 31 of the LD 30 and a light incidence surface (a side surface) 200A of the optical coupler 200 are disposed at a predetermined interval. The light incidence surface 200A faces the light emission surface 31, and there is a gap S between the light emission surface 31 and the light incidence surface 200A in the x direction. Since the visible light source module 1000 is exposed to air, the gap S is filled with air. Since the gap S is filled with the same gas (air), it is easy to make each color light emitted from each of the LDs 30 be incident on an incidence path in a state in which a predetermined coupling efficiency is satisfied. When the visible light source module 1000 is used for AR glasses or VR glasses, a size of the gap (interval) S in the x direction is, for example, larger than 0 μm and equal to or smaller than 5 μm, considering the amount of light required for the AR glasses or VR glasses.

### Visible Light Source Module (Second Embodiment)

The visible light source module according to a second embodiment includes the optical coupler according to the present embodiment and a plurality of visible laser light sources that emit visible lights that are coupled by the optical coupler.

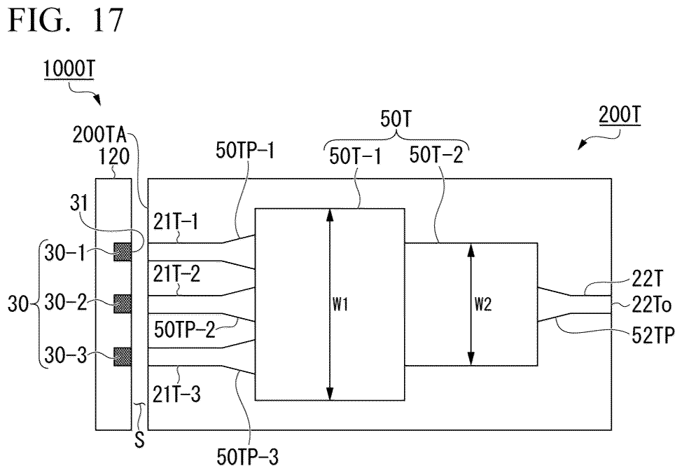

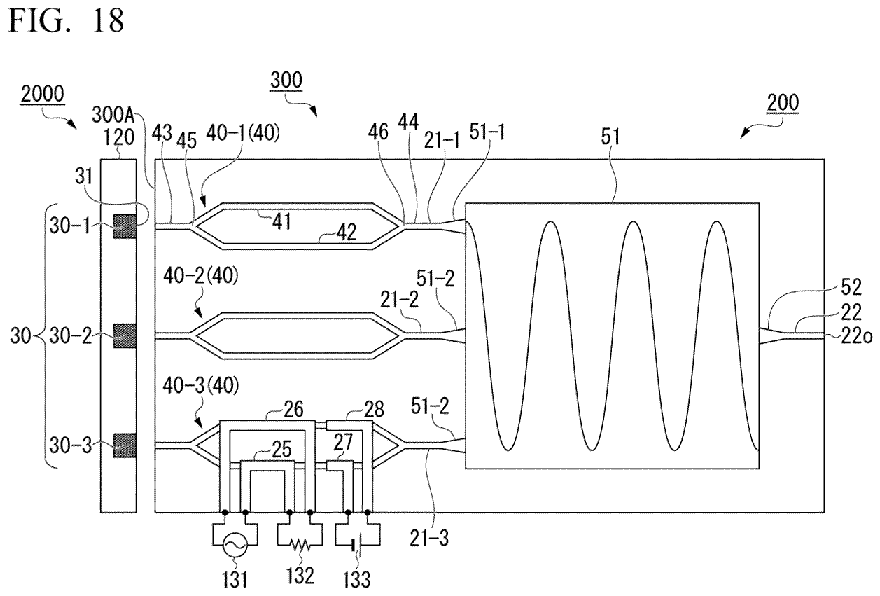

FIG. 17 is a schematic plan view of the visible light source module according to the second embodiment. FIG. 17 shows an example of a visible light source module including the optical coupler 200T shown in FIG. 10.

The visible light source module 1000T shown in FIG. 17 includes the optical coupler 200T shown in FIG. 15 and a plurality of visible laser light sources 30 (30-1, 30-2 and 30-3) that emit visible lights that are coupled by the optical coupler 200T.

### Visible Light Source Module (Third Embodiment)

FIG. 18 is a schematic plan view of a visible light source module according to the third embodiment.

The visible light source module 2000 shown in FIG. 18 includes the optical coupler 300 with a light modulation function shown in FIG. 14 and a plurality of visible laser light sources 30 (30-1, 30-2, 30-3) which emit visible lights that are coupled by the optical coupler 300 with a light modulation function. The optical coupler 300 includes a substrate 10 (refer to FIG. 10) made of a material different from lithium niobate, and an optical coupling functional layer 20 (refer to FIG. 10) formed on a main surface of the substrate 10 and made of lithium niobate, and has a side surface 300A.

Regarding the constituent elements shown in FIG. 18, constituent elements having the same functions as those described above may be designated by the same reference numerals, and a description thereof may be omitted.

The visible light source module 2000 includes three Mach-Zehnder type optical waveguides 40-1, 40-2 and 40-3 of which the number is the same as that of the visible laser light sources 30-1, 30-2 and 30-3. The visible laser light sources 30-1, 30-2 and 30-3 and the Mach-Zehnder type optical waveguides 40-1, 40-2 and 40-3 are positioned so that the lights emitted from the visible laser light sources are incident on the corresponding Mach-Zehnder type optical waveguides.

The subcarrier 120 on which the visible laser light sources 30-1, 30-2 and 30-3 are mounted and the substrate 10 on which the optical coupling functional layer 20 having the optical coupler 300 with a light modulation function is formed can be directly bonded via a metal bonding layer. With such a configuration, further miniaturization is possible by not performing spatial coupling or fiber coupling.

In addition, a relative position between the subcarrier 120 and the substrate 10 is adjusted during manufacturing, and alignment of the position of the optical axis of the visible laser light can be performed so that the optical axis of each optical laser matches the axis of each of the input paths 43 of the Mach-Zehnder type optical waveguides 40-1, 40-2 and 40-3 (active alignment).

A size of the optical coupling functional layer 20 is, for example, 100 mm² or less. When the size of the optical coupling functional layer 20 is 100 mm² or less, it is suitable for use in xR glasses such as AR glasses and VR glasses.

The optical coupling functional layer 20 can be produced by a known method. For example, the optical coupling functional layer 20 is manufactured using a semiconductor process such as epitaxial growth, photolithography, etching, vapor phase growth, and metallization.

When the visible light source module according the present disclosure is applied as xR glasses such as AR glasses and VR glasses, the width of the MMI type optical coupling main body constituting the optical coupler is preferably, about 1 to 1000 μm, for example, and the length thereof is preferably about 10 to 10000 μm, for example.

### Visible Light Source Module (Fourth Embodiment)

A visible light source module according to a fourth embodiment includes the optical coupler according to the present embodiment and a plurality of visible laser light sources that emit visible lights that are coupled by the optical coupler.

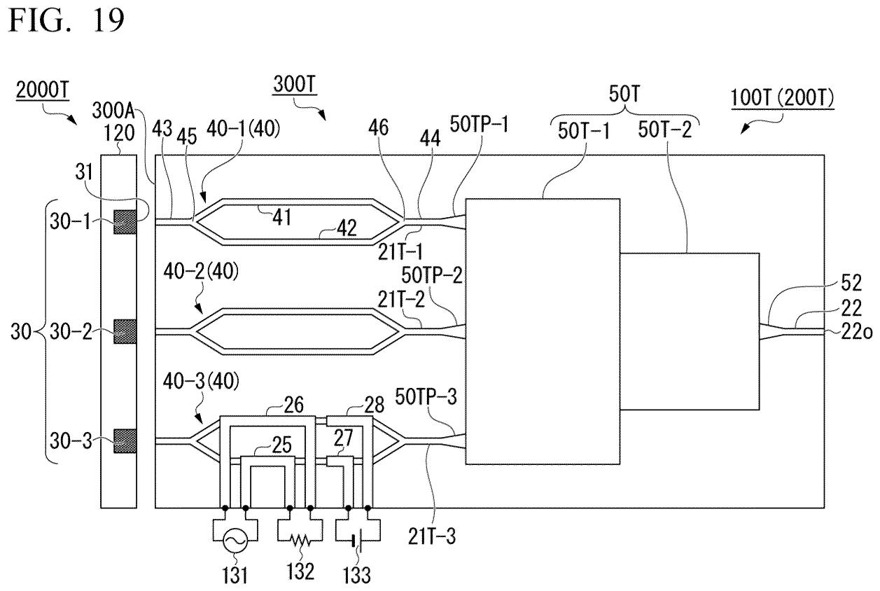

FIG. 19 is a schematic plan view of the visible light source module according to the fourth embodiment. FIG. 19 shows an example of a visible light source module including the optical coupler 200T shown in FIG. 10.

The visible light source module 2000T shown in FIG. 19 includes the optical coupler 300T with an optical modulation function shown in FIG. 15 and a plurality of visible laser light sources 30 (30-1, 30-2 and 30-3) which emit visible lights that are coupled by the optical coupler 300T with an optical modulation function. The optical coupler 300 includes a substrate 10 (refer to FIG. 10) made of a material different from lithium niobate, and an optical coupling functional layer 20 (refer to FIG. 10) formed on a main surface of the substrate 10 and made of lithium niobate, and has a side surface 300A.

For example, in a retinal projection display, in order to display an image in a desired color, it is necessary to independently and quickly modulate an intensity of each of three colors of RGB representing visible light. When such modulation is performed only on a visible laser light source (current modulation), a load on an IC that controls the modulation will become large, but modulation (voltage modulation) by the Mach-Zehnder type optical modulator 40 (the optical coupler 300 with an optical modulation function) can also be used. In this case, coarse adjustment may be performed using a current (the visible laser light source), and fine adjustment may be performed using a voltage (the Mach-Zehnder type optical modulator 40), and also the coarse adjustment may be performed using the voltage (the Mach-Zehnder type optical modulator 40), and the fine adjustment may be performed using the current (the visible laser light source). Preferably, since responsiveness is better when fine adjustments are performed using the voltage, when responsiveness is important, the former is adopted, and since performing fine adjustment using a current requires a lower current and thus curbs power consumption, when curbing power consumption is important, the latter is adopted.

### [Optical Engine]

In the specification, an optical engine is a device including a plurality of light sources, an optical system including a coupling part that couples a plurality of lights emitted from the plurality of light sources into one light, and a light scanning mirror that reflects the light emitted from the optical system by changing an angle so as to display an image, and a control element that controls the light scanning mirror.

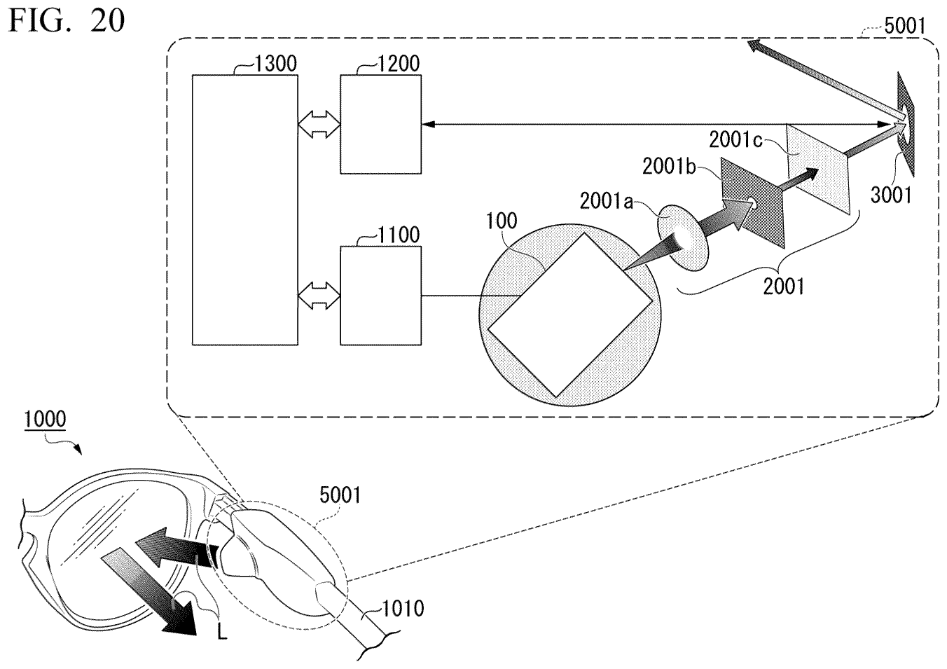

FIG. 20 shows a conceptual diagram showing an optical engine 5001 according to this embodiment. The drawing shows a state in which the optical engine 5001 is installed in a frame 10010 of glasses 10000. Symbol Lis image display light.

The optical engine 5001 includes a visible light source module 1001 and a light scanning mirror 3001. As the visible light source module 1001 included in the optical engine 5001, the visible light source module according to the embodiment described above is used.

Laser light emitted from the visible light source module 1001 installed in a glasses frame is reflected and scanned by the light scanning mirror, enters the human eye, and an image (a video) is directly projected onto the retina.

The light scanning mirror 3001 is, for example, a MEMS mirror. In order to project a 2D image, it is preferably a two-axis MEMS mirror that vibrates to reflect laser light while an angle thereof is changed in a horizontal direction (an X direction) and a vertical direction (a Y direction).

The optical engine 5001 includes a collimator lens 2001a, a slit 2001b, and an ND filter 2001c as an optical system that optically processes the laser light emitted from the visible light source module 1001. This optical system is just an example, and other configurations may be used.

The optical engine 5001 includes a laser driver 1100, a light scanning mirror driver 1200, and a video controller 1300 that controls the drivers.

### EXAMPLES

Hereinafter, the present disclosure will be described in more detail using examples. However, the present disclosure is not limited to the examples shown below.

For the case of an example in which the width Wout of the output taper portion is wider than the width W1in of the input taper portion (the width is the same in the entire input taper portion) and the case of the comparative example in which the width Wout of the output taper portion is the same as the width W1in of the input taper portion (the width is the same in the entire input taper portion), the coupling loss of the three colored lights of RGB (loss of the light intensity at the time of output after the light intensity at the time of input of each light passes through the MMI coupler) was calculated by a simulation. Fimmwave (created by Photon Design Co.) was used as simulation software.
[3×1 MMI (1 stage)]

### Example 1 to Example 8

The coupling loss of the three colored lights of RGB was calculated using a model of the 3×1 type optical coupler shown in FIG. 2.

Example 1 had the following dimensions.
Width of optical coupling main body: 13 μm
Length of optical coupling main body: 5552 μm
Width Win of input taper portion: 1 μm
Width Wout of output taper portion: 1.5 μm

In addition, in the arrangement of input of three colors of RGB, center input was set to green (G).

The coupling losses were 7.0 dB, 5.2 dB and 6.3 dB in order of RGB.

The widths W1in, W2 in, and W3in of the three input taper portions were assumed to be the same and were collectively referred to as Win. The same applies below.

In Examples 2 to 8, the width of the input taper portion and/or the width of the output taper portion of Example 1 were changed.

In Examples 2 and 3, the width of the input taper portion was 1 μm which is the same as the width of the input taper portion of Example 1, but the width of the output taper portion was 2.0 μm and 2.5 μm, respectively.

In all of Examples 4 to 6, the width of the input taper portion was 1.5 μm, but the width of the output taper portion was 1.8 μm, 2.0 μm and 2.5 μm, respectively.

In Examples 7 and 8, the width of the input taper portion was 2.0 μm, but the width of the output taper portion was 2.3 μm and 2.5 μm, respectively.

The coupling loss of each of the examples is shown in Table 1.

### Comparative Example 1 to Comparative Example 3

In Comparative example 1, a simulation was performed with the same dimensions as Examples 1 to 3, except that the width of the input taper portion is 1 μm which is the same as the width of the input taper portions of Examples 1 to 3, and the width of the output taper portion is also 1 μm.

In Comparative example 2, a simulation was performed with the same dimensions as Examples 4 to 6, except that the width of the input taper portion was 1.5 μm which is the same as the width of the input taper portions of Examples 4 to 6, and the width of the output taper portion was also 1.5 μm.

In Comparative example 3, a simulation was performed with the same dimensions as Examples 7 and 8, except that the width of the input taper portion was 2 μm which is the same as the width of the input taper portions of Examples 7 and 8, and the width of the output taper portion was also 2 μm.

The coupling loss of each of the comparative examples is as shown in Table 2.
[3×1 MMI (2 stages)]

### Example 9 to Example 16

The coupling loss of the three colors of RGB was calculated using a model of the 3×1 type optical coupler with two stages shown in FIG. 7.

Example 9 had the following dimensions.
Width of the first stage optical coupling part body: 13 μm
Width of the second stage optical coupling part body: 7 μm
Length of the first stage optical coupling main body: 325 μm
Length of the second stage optical coupling main body: 670 μm
Width Win of input taper portion: 1 μm
Width Wout of output taper portion: 1.5 μm

In addition, in the arrangement of input of three colors of RGB, the center input was set to blue (B).

The coupling losses were 6.0 dB, 7.5 dB, and 5.6 dB in the order of RGB.

In Examples 10 to 14, the width of the input taper portion and/or the width of the output taper portion of Example 9 were changed.

In Examples 10 and 11, the width of the input taper portion was 1 μm which is the same as the width of the input taper portion of Example 9, but the width of the output taper portion was 2.0 μm and 2.5 μm, respectively.

In Examples 12 and 13, the width of the input taper portion was 1.5 μm, but the width of the output taper portion was 2.0 μm and 2.5 μm, respectively.

In Example 14, the width of the input taper portion was 2.0 μm, but the width of the output taper portion was 2.5 μm.

Example 15 had similar dimensions to Example 14, except that the lengths of the first and second stage optical coupling part main bodies were 480 μm and 950 μm, respectively, and the center input was red (R) in the arrangement of input of three colors of RGB.

Example 16 had similar dimensions to Example 14, except that the lengths of the first and second stage optical coupling unit bodies were 480 μm and 480 μm, respectively, and the center input was green (G) in the arrangement of input of three colors of RGB.

The coupling loss of each of the examples is shown in Table 1.

### Comparative Example 4 to Comparative Example 8

In Comparative example 4, a simulation was performed with the same dimensions as Examples 1 to 3, except that the width of the input taper portion was 1 μm which is the same as the width of the input taper portion of Examples 9 to 11, and the width of the output taper portion was also 1 μm.

In Comparative example 5, a simulation was performed with the same dimensions as Examples 12 and 13, except that the width of the input taper portion was 1.5 μm which is the same as the width of the input taper portion of Examples 12 and 13, and the width of the output taper portion was also 1.5 μm.

In Comparative example 6, a simulation was performed with the same dimensions as in Example 14, except that the width of the input taper portion was 2 μm which is the same as the width of the input taper portion of Example 14, and the width of the output taper portion was also 2 μm.

In Comparative example 7, a simulation was performed with the same dimensions as in Example 15, except that the width of the input taper portion was 2 μm which is the same as the width of the input taper portion of Example 15, and the width of the output taper portion was also 2 μm.

In Comparative example 8, a simulation was performed with the same dimensions as in Example 16, except that the width of the input taper portion was 2 μm which is the same as the width of the input taper portion of Example 16, and the width of the output taper portion was also 2 μm.

The coupling loss of each of the comparative examples is as shown in Table 2.
[2×1 MMI (1 stage)]

### Example 17 to Example 27

The coupling loss of the three colors of RGB was calculated using a model of the 2×1 type optical coupler shown in FIG. 1.

In all Examples 17 to 27, the width of the optical coupling main body was 6.5 μm, but the length of the optical coupling main body was 750 μm in Example 17, 800 μm in Examples 18 to 24, and 850 μm in Examples 25 to 27.

In Example 17, the widths of the input taper portion and the output taper portion were set to the following dimensions.
Width W1in of input taper portion: 2 μm
Width Wout of output taper portion: 2.5 μm

The coupling loss was 3.0 dB and 2.3 dB in the order of RG.

In Examples 18 to 24, the widths of the input taper portion and the output taper portion were set to the following dimensions. In Examples 18 to 20, the width of the input taper portion was 1 μm, but the width of the output taper portion was 1.5 μm, 2.0 μm and 2.5 μm, respectively.

In Examples 21 and 22, the width of the input taper portion was 1.5 μm, but the width of the output taper portion was 2.0 μm and 2.5 μm, respectively.

In Examples 23 and 24, the width of the input taper portion was 2.0 μm, but the width of the output taper portion was 2.2 μm and 2.5 μm, respectively.

In Examples 25 to 27, the widths of the input taper portion and the output taper portion were set to the following dimensions. In Examples 25 and 26, the width of the input taper portion was 1 μm, but the width of the output taper portion was 1.5 μm and 2.5 μm, respectively.

In Example 27, the width of the input taper portion was 2 μm, but the width of the output taper portion was 2.5 μm.

### Comparative Example 9 to Comparative Example 14

In Comparative example 9, as in Example 17, the width of the optical coupling main body was 6.5 μm, and the length of the optical coupling main body was 750 μm, and the width of the input taper portion and the width of the output taper portion were both 2.0 μm.

In Comparative example 10, as in Examples 18 to 24, the width of the optical coupling main body was 6.5 μm, the length of the optical coupling main body was 800 μm, and the width of the input taper portion and the width of the output taper portion were both 1.0 μm.

In Comparative example 11, as in Examples 18 to 24, the width of the optical coupling main body was 6.5 μm, the length of the optical coupling main body was 800 μm, and both the width of the input taper portion and the width of the output taper portion were 1.5 μm.

In Comparative example 12, as in Examples 18 to 24, the width of the optical coupling main body was 6.5 μm, the length of the optical coupling main body was 800 μm, and both the width of the input taper portion and the width of the output taper portion were 2.0 μm.

In Comparative example 13, as in Examples 25 to 27, the width of the optical coupling main body was 6.5 μm, the length of the optical coupling main body was 850 μm, and both the width of the input taper portion and the width of the output taper portion were 1.0 μm.

In Comparative example 14, as in Examples 25 to 27, the width of the optical coupling main body was 6.5 μm, the length of the optical coupling main body was 850 μm, and both the width of the input taper portion and the width of the output taper portion were 2.0 μm.

The coupling loss of each of the comparative examples is as shown in Table 2.

TABLE 1

| | | | | | | | | Coupled | | | | |
|---|---|---|---|---|---|---|---|---|---|---|---|---|
| | | Taper width | | | | | | light | | | | |
| | | Input | Output | | Coupling loss | | | *( ) is | Width (μm) | | Length (μm) | |
| | | side | side | MMI | (dB) | | | 3 × 1 | First | Second | First | Second |
| | | (μm) | (μm) | configuration | R | G | B | Center | stage | stage | stage | stage |
| Examples | 1 | 1 | 1.5 | 3 × 1 MMI | 7.0 | 5.2 | 6.3 | RGB | 13 | — | 5552 | — |
| | | | | | | | | (G) | | | | |
| | 2 | 1 | 2 | 3 × 1 MMI | 6.5 | 5.2 | 6.2 | RGB | 13 | — | 5552 | — |
| | | | | | | | | (G) | | | | |
| | 3 | 1 | 2.5 | 3 × 1 MMI | 6.0 | 5.0 | 5.9 | RGB | 13 | — | 5552 | — |
| | | | | | | | | (G) | | | | |
| | 4 | 1.5 | 1.8 | 3 × 1 MMI | 6.0 | 5.5 | 6.0 | RGB | 13 | — | 5552 | — |
| | | | | | | | | (G) | | | | |
| | 5 | 1.5 | 2 | 3 × 1 MMI | 6.0 | 5.5 | 6.0 | RGB | 13 | — | 5552 | — |
| | | | | | | | | (G) | | | | |
| | 6 | 1.5 | 2.5 | 3 × 1 MMI | 5.8 | 5.3 | 5.8 | RGB | 13 | — | 5552 | — |
| | | | | | | | | (G) | | | | |
| | 7 | 2 | 2.3 | 3 × 1 MMI | 5.0 | 5.9 | 5.5 | RGB | 13 | — | 5552 | — |
| | | | | | | | | (G) | | | | |
| | 8 | 2 | 2.5 | 3 × 1 MMI | 5.0 | 5.9 | 5.5 | RGB | 13 | — | 5552 | — |
| | | | | | | | | (G) | | | | |
| | 9 | 1 | 1.5 | 3 × 1 MMI | 6.0 | 7.5 | 5.6 | RGB | 13 | 7 | 325 | 670 |
| | | | | (two stages) | | | | (B) | | | | |
| | 10 | 1 | 2 | 3 × 1 MMI | 6.0 | 6.7 | 5.5 | RGB | 13 | 7 | 325 | 670 |
| | | | | (two stages) | | | | (B) | | | | |
| | 11 | 1 | 2.5 | 3 × 1 MMI | 6.0 | 6.4 | 5.5 | RGB | 13 | 7 | 325 | 670 |
| | | | | (two stages) | | | | (B) | | | | |
| | 12 | 1.5 | 2 | 3 × 1 MMI | 5.3 | 4.9 | 4.5 | RGB | 13 | 7 | 325 | 670 |
| | | | | (two stages) | | | | (B) | | | | |
| | 13 | 1.5 | 2.5 | 3 × 1 MMI | 5.3 | 4.9 | 4.0 | RGB | 13 | 7 | 325 | 670 |
| | | | | (two stages) | | | | (B) | | | | |
| | 14 | 2 | 2.5 | 3 × 1 MMI | 4.6 | 4.4 | 3.9 | RGB | 13 | 7 | 325 | 670 |
| | | | | (two stages) | | | | (B) | | | | |
| | 15 | 2 | 2.5 | 3 × 1 MMI | 4.7 | 6.5 | 4.8 | RGB | 13 | 7 | 480 | 950 |
| | | | | (two stages | | | | (R) | | | | |
| | 16 | 2 | 2.5 | 3 × 1 MMI | 6.1 | 4.8 | 4.8 | RGB | 13 | 7 | 480 | 480 |
| | | | | (two stages) | | | | (G) | | | | |
| | 17 | 2 | 2.5 | 2 × 1 MMI | 3.0 | 2.3 | — | RG | 6.5 | — | 750 | — |
| | 18 | 1 | 1.5 | 2 × 1 MMI | 1.8 | 1.8 | — | RG | 6.5 | — | 800 | — |
| | 19 | 1 | 2 | 2 × 1 MMI | 1.5 | 1.4 | — | RG | 6.5 | — | 800 | — |
| | 20 | 1 | 2.5 | 2 × 1 MMI | 2.1 | 1.6 | — | RG | 6.5 | — | 800 | — |
| | 21 | 1.5 | 2 | 2 × 1 MMI | 1.2 | 1 | — | RG | 6.5 | — | 800 | — |
| | 22 | 1.5 | 2.5 | 2 × 1 MMI | 1.2 | 1 | — | RG | 6.5 | — | 800 | — |
| | 23 | 2 | 2.2 | 2 × 1 MMI | 0.9 | 0.8 | — | RG | 6.5 | — | 800 | — |
| | 24 | 2 | 2.5 | 2 × 1 MMI | 0.9 | 0.8 | — | RG | 6.5 | — | 800 | — |
| | 25 | 1 | 1.5 | 2 × 1 MMI | 5.3 | 0.8 | — | RG | 6.5 | — | 850 | — |
| | 26 | 1 | 2.5 | 2 × 1 MMI | 4.7 | 3.7 | — | RG | 6.5 | — | 850 | — |
| | 27 | 2 | 2.5 | 2 × 1 MMI | 3.0 | 2.7 | — | RG | 6.5 | — | 850 | — |

TABLE 2

| | | | | | | | | Coupled | | | | |
|---|---|---|---|---|---|---|---|---|---|---|---|---|
| | | Taper width | | | | | | light | | | | |
| | | Input | Output | | Coupling loss | | | *( ) is | Width (μm) | | Length (μm) | |
| | | side | side | MMI | (dB) | | | 3 × 1 | First | Second | First | Second |
| | | (μm) | (μm) | configuration | R | G | B | center | stage | stage | stage | stage |
| Comparative | 1 | 1 | 1 | 3 × 1 MMI | 7.5 | 5.3 | 6.5 | RGB (G) | 13 | — | 5552 | — |
| example | 2 | 1.5 | 1.5 | 3 × 1 MMI | 7.0 | 5.5 | 6.5 | RGB (G) | 13 | — | 5552 | — |
| | 3 | 2 | 2 | 3 × 1 MMI | 6.0 | 6.0 | 6.0 | RGB (G) | 13 | — | 5552 | — |
| | 4 | 1 | 1 | 3 × 1 MMI | 6.5 | 9.2 | 6.5 | RGB (B) | 13 | 7 | 325 | 670 |
| | | | | (two stages) | | | | | | | | |
| | 5 | 1.5 | 1.5 | 3 × 1 MMI | 5.5 | 5.0 | 6.0 | RGB (B) | 13 | 7 | 325 | 670 |
| | | | | (two stages) | | | | | | | | |
| | 6 | 2 | 2 | 3 × 1 MMI | 4.8 | 5.0 | 4.1 | RGB (B) | 13 | 7 | 325 | 670 |
| | | | | (two stages) | | | | | | | | |
| | 7 | 2 | 2 | 3 × 1 MMI | 5.0 | 7.0 | 5.0 | RGB (R) | 13 | 7 | 480 | 950 |
| | | | | (two stages) | | | | | | | | |
| | 8 | 2 | 2 | 3 × 1 MMI | 6.5 | 5.0 | 5.0 | RGB (G) | 13 | 7 | 480 | 480 |
| | | | | (two stages) | | | | | | | | |
| | 9 | 2 | 2 | 2 × 1 MMI | 4.0 | 3.0 | — | RG | 6.5 | — | 750 | — |
| | 10 | 1 | 1 | 2 × 1 MMI | 2.2 | 2.0 | — | RG | 6.5 | — | 800 | — |
| | 11 | 1.5 | 1.5 | 2 × 1 MMI | 1.3 | 1.1 | — | RG | 6.5 | — | 800 | — |
| | 12 | 2 | 2 | 2 × 1 MMI | 1.0 | 1.3 | — | RG | 6.5 | — | 800 | — |
| | 13 | 1 | 1 | 2 × 1 MMI | 5.5 | 5.8 | — | RG | 6.5 | — | 850 | — |
| | 14 | 2 | 2 | 2 × 1 MMI | 3.5 | 3.5 | — | RG | 6.5 | — | 850 | — |

As described above, when the examples and the comparative examples are compared, it was understood that the coupling loss can be reduced in any of the 3×1 MMI configuration (one stage), the 3×1 MMI configuration (two stages), and the 2×1 MMI configuration.

In Examples 1 to 8 (3×1 MMI configuration (1 stage)), regarding the optical coupling main body with a width of 13 μm and the length of 5552 μm, when the width of the input taper portion on the input side (the incident side) is 1 to 2 μm, the width of the output taper portion on the output side (the output side) was calculated as being 0.3 to 1.5 μm wider than the width of the input taper portion.

When the width of the input taper portion is 1 μm, the coupling loss is lower in the case in which the width of the output taper portion is 2 μm (Example 2) than in the case in which the width of the output taper portion is 1.5 μm (Example 1), when the width of the output taper portion was 2.5 μm (Example 3), the coupling loss could be further reduced. Moreover, when the width of the input taper portion is 1.5 μm, the coupling loss was the same in the case in which the width of the output taper portion was 1.8 μm (Example 4) and in the case in which the width of the output taper portion was 2 μm (Example 5), but when the width of the output taper portion was 2.5 μm (Example 6), the coupling loss could be reduced. Further, when the width of the input taper portion was 2 μm, the coupling loss was the same as that in the case in which the width of the output taper portion was 2.3 μm (Example 7) and in the case in which the width of the output taper portion was 2.5 μm (Example 8).

In Examples 9 to 14 (3×1 MMI configuration (2 stages)), for the optical coupling main body in which the first stage optical coupling unit body has a width of 13 μm and the length of 325 μm and the second stage optical coupling unit body has a width of 7 μm and the length of 670 μm, when the width of the input taper portion on the input side (the incident side) is set to 1 to 2 μm, the width of the output taper portion on the output side (the output side) was calculated as being 0.5 to 1.5 μm wider than the width of the input taper portion.

When the width of the input taper portion is 1 μm, the coupling loss is lower in the case in which the width of the output taper portion is 2 μm (Example 10) than in the case in which the width of the output taper portion is 1.5 μm (Example 9), and when the width of the output taper portion was 2.5 μm (Example 11), the coupling loss could be further reduced. Further, when the width of the input taper portion is 1.5 μm, the coupling loss was more reduced in the case in which the width of the output taper portion was 2.5 μm (Example 13) than in the case in which the width of the output taper portion was 2 μm (Example 12).

In Examples 15 and 16, in the arrangement of input of three colors of RGB, the center inputs are not blue (B) but red (R) and green (G), respectively. Although the coupling loss can be sufficiently reduced in all cases, the coupling loss is larger than that in Example 14 which has the same dimensions except for the length of the optical coupling main body.
[3×1 MMI (1 stage)]

In all of Examples 1 to 3, the coupling loss was curbed compared to Comparative Example 1 in which the input taper portion had the same width of 1 μm.

In all of Examples 4 to 6, the coupling loss was curbed compared to Comparative Example 2 in which the input taper portion had the same width of 1.5 μm.

In all of Examples 7 and 8, the coupling loss was curbed compared to Comparative Example 3 in which the input taper portion had the same width of 2 μm.
[3×1 MMI (2 stages)]

In all of Examples 9 to 11, the coupling loss was curbed compared to Comparative Example 4 in which the input taper portion had the same width of 1 μm.

In all of Examples 12 and 13, the coupling loss was curbed compared to Comparative Example 5 in which the input taper portion had the same width of 1.5 μm.

In Example 14, the coupling loss was curbed compared to Comparative Example 6 in which the input taper portion had the same width of 2 μm.

In Example 15, the coupling loss was curbed compared to Comparative Example 7 in which the input taper portion had the same width of 2 μm.

In Example 16, the coupling loss was curbed compared to Comparative Example 8 in which the input taper portion has the same width of 2 μm.
[2×1 MMI (1 stage)]

In Example 17, the coupling loss was curbed compared to Comparative Example 9 in which the input taper portion had the same width of 2 μm.

In Examples 18 to 20, the coupling loss was curbed compared to Comparative Example 10 in which the input taper portion had the same width of 1 μm.

In Examples 21 and 22, the coupling loss was curbed compared to Comparative Example 11 in which the input taper portion had the same width of 1.5 μm.

In Examples 23 and 24, the coupling loss was curbed compared to Comparative Example 12 in which the input taper portion had the same width of 2 μm.

In Examples 25 and 26, the coupling loss was curbed compared to Comparative Example 13 in which the input taper portion had the same width of 1 μm.

In Example 27, the coupling loss was curbed compared to Comparative Example 14 in which the input taper portion had the same width of 2 μm.

### DESCRIPTION OF REFERENCES

10 Substrate
20 Optical coupling functional layer
30 Visible laser light source
40 Mach-Zehnder type optical modulator
50, 50T, 51 Optical coupling main body
50-1, 50T-1, 51-1 Input taper portion
50-1A, 50-2A, 51-1A, 51-2A, 51-3A Connection end
52, 52T Output taper portion
100, 100T, 101, 200, 200T Optical coupler
300, 300T Optical coupler with light modulation function
1000, 2000 Visible light source module
5001 Optical engine

What is claimed is:

1. A multimode interference type optical coupler that couples a plurality of laser lights of different wavelengths, comprising:
an optical coupling main body;
a plurality of input taper portions which are tapered input ports, wherein the plurality of input taper portions are disposed on an input side of the optical coupling main body and a width of each of the plurality of input taper portions becomes narrower as it is away from a connection end with the optical coupling main body; and
one output taper portion which is a tapered output port, wherein the output taper portion is disposed on an output side of the optical coupling main body and a width of the output taper portion becomes narrower as it is away from a connection end with the optical coupling main body,
wherein a width of a connection end of the output taper portion is wider than a width of any one of connection ends of the plurality of input taper portions.

2. The optical coupler according to claim 1, wherein the optical coupler is a 3-input and 1-output type or a 2-input and 1-output type.

3. The optical coupler according to claim 1, wherein all of the plurality of different wavelengths are visible light wavelengths.

4. The optical coupler according to claim 3, wherein the visible light wavelengths are a red wavelength of 610 nm or more and 750 nm or less, a green wavelength of 500 nm or more and 560 nm or less, and a blue wavelength of 435 nm or more and 480 nm or less.

5. The optical coupler according to claim 1, wherein the optical coupling main body has a first MMI type optical coupling main body and a second MMI type optical coupling main body which are connected in this order from an input side,
a width of the second MMI type optical coupling main body is narrower than a width of the first MMI type optical coupling main body,
the plurality of input taper portions are provided on an input side of the first MMI type optical coupling main body, and
the output taper portion is provided on an output side of the second MMI type optical coupling main body.

6. The optical coupler according to claim 5, wherein a connection portion of the second MMI type optical coupling main body with the first MMI type optical coupling main body has a width changing portion that becomes wider as it approaches the first MMI type optical coupling main body.

7. The optical coupler according to claim 1, further comprising:
a substrate made of a material different from lithium niobate; and
an optical coupling functional layer formed on a main surface of the substrate and made of a lithium niobate film,
wherein the optical coupler is formed in the optical coupling functional layer.

8. The optical coupler according to claim 5, further comprising:
a substrate made of a material different from lithium niobate; and
an optical coupling functional layer made of a lithium niobate film formed on the main surface of the substrate,
wherein the optical coupler is formed in the optical coupling functional layer.

9. A visible light source module comprising:
the optical coupler according to claim 1; and
a plurality of visible laser light sources configured to emit visible lights that are coupled by the optical coupler.

10. An optical coupler with an optical modulation function, comprising:
the optical coupler according to claim 1; and
a Mach-Zehnder type optical modulator connected to the optical coupler and configured to guide a plurality of visible lights emitted from a plurality of visible laser light sources to the optical coupler.

11. A visible light source module comprising:
the optical coupler with a light modulation function according to claim 10; and
a plurality of visible laser light sources configured to emit visible lights that are coupled by the optical coupler with a light modulation function.

12. An optical engine comprising:
the visible light source module according to claim 9; and
a light scanning mirror that reflects the light emitted from the visible light source module by changing an angle to display an image.

13. An optical engine comprising:
the visible light source module according to claim 11; and
a light scanning mirror that reflects the light emitted from the visible light source module by changing an angle to display an image.
